(19) United States
(12) Patent Application Publication
(10) Pub. No.: US 2026/0022261 A1
(43) Pub. Date: Jan. 22, 2026

(54) SECURITY INK COMPOSITION AND MACHINE-READABLE SECURITY FEATURE DERIVED THEREFROM

(71) Applicant: SICPA HOLDING SA, Prilly (CH)

(72) Inventors: Lorenzo SIRIGU, Lausanne (CH); Anissa DE LATTRE, Ardon (CH); Oscar DE FEO, Lausanne (CH); Mathieu GILLIERON, Cossonay-Ville (CH); Florence FAVARO, Arnex sur Orbe (CH)

(21) Appl. No.: 18/995,670

(22) PCT Filed: Aug. 17, 2023
(86) PCT No.: PCT/EP2023/072677

§ 371 Date: Jan. 16, 2025

(30) Foreign Application Priority Data
Aug. 23, 2022 (EP) 22191813.9

(51) Int. Cl. C09D 11/037; B42D 25/29; B42D 25/369; B42D 25/373; C01G 49/00; G07D 7/04

(52) U.S. Cl. CPC C09D 11/037; B42D 25/369; B42D 25/373; C01G 49/0054; G07D 7/04; B42D 25/29; C01P 2002/54; C01P 2002/86; C01P 2006/42; G07D 2207/00

(57) ABSTRACT

A security ink composition comprising at least one non-luminescent undoped Y₃Fe₅₋ₓMₓO₁₂-based pigment, wherein x fulfils the condition 0≤x≤1.25; M is selected from a group consisting of aluminum, gallium or calcium and mixtures thereof, and wherein an applied, preferably printed, at least one machine-readable security feature derived from said security ink composition, after drying and/or curing, has an integrated magnetic susceptibility of at least about 200×10⁻¹²m³ and presents a ferromagnetic resonance (FMR) signature for authentication purposes. A method for authentication of a machine-readable security feature derived from the security ink composition.

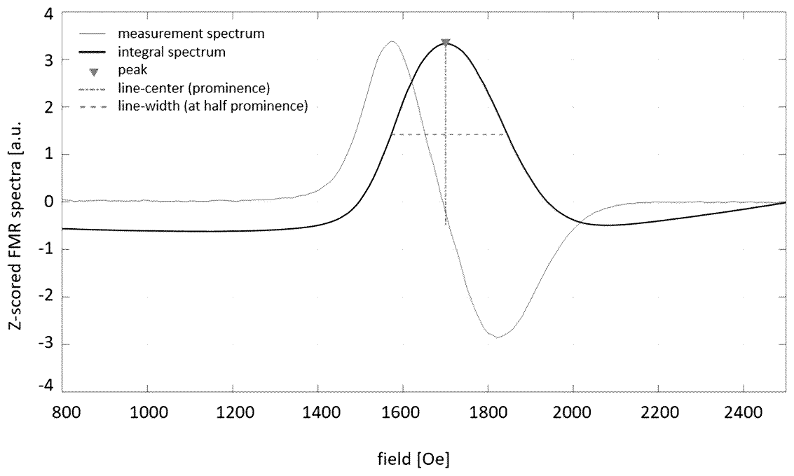

The present invention relates to the field of ferromagnetic security inks suitable for printing detectable machine-readable security features on substrates, particularly on security documents and/or articles.

### BACKGROUND

With the constantly improving quality of color photocopies and printings and in an attempt to protect security documents such as banknotes, value documents or cards, transportation tickets or cards, tax banderols, and product labels that have no reproduceable effects against counterfeiting, falsifying or illegal reproduction, it has been the conventional practice to incorporate various security means features in these documents.

Security features, e.g. for security documents, can be classified into “covert” and “overt” security features. The protection provided by covert security features relies on the concept that such features are hidden, typically requiring specialized equipment and knowledge for their detection, whereas “overt” security features are easily detectable with the unaided human senses, e.g. such features may be visible and/or detectable via the tactile senses while still being difficult to produce and/or to copy.

Machine-readable security inks, such as for example magnetic inks, luminescent inks and IR-absorbing inks, have been widely used in the field of security documents, in particular for banknotes printing, to confer the security document an additional covert security feature. The protection of security document against counterfeit and illegal reproduction provided by covert security features relies on the concept that such features typically require specialized equipment and knowledge for their detection. In the field of security and protecting value documents and value commercial goods or articles against counterfeiting, falsifying and illegal reproduction, it is known in the art to apply machine-readable security inks by different printing processes including printing processes using highly viscous or pasty inks such as offset printing, letterpress printing and intaglio printing (also referred in the art as engraved steel die or copper plate printing), liquid inks such as rotogravure printing, flexography printing, screen printing and inkjet printing.

Magnetic detection methods are known in the art and provide for covert detection of security documents and articles. Paramagnetic detection methods have been described in WO 2020/245280 A1, U.S. Pat. No. 4,376,264 or US 2010/224819 A1. Another magnetic detection method relies on ESR/NMR detection technologies e.g. U.S. Pat. No. 5,986,550. Magnetic resonance detection can be employed for ferrimagnetic, ferromagnetic or paramagnetic security features.

Yet another magnetic detection method depends on ferromagnetism. Ferromagnetism is a mechanism by which certain materials form permanent magnets or are attracted to magnets. It is well known in the art that ferromagnetism is the strongest type of magnetism and ferromagnetic detection methods provide strong magnetic signals which can be employed for example in ATMs or high-speed sorting (HSS) machines for quick and reliable magnetic detection.

In comparison, paramagnetic species usually provide low intensity signals and require higher B-field and excitation frequencies for higher concentrations. Therefore, paramagnetic species need to be included in rather high amounts in the security ink compositions. This might lead to inhomogeneity issues and adds additional costs. NMR detection requires complex instrumentation and processes, which makes their incorporation into ATMs and HSS-machines impractical. Thus, ferromagnetic detection methods and security features based thereon provide practical and efficient detection and authentication services for security documents and/or articles.

Additionally, modern machine-readable security features do not rely only on one specific security feature. Rather, it is common and indeed advantageous to incorporate multiple covert and/or overt security features to make it difficult to counterfeit the security features. Another advantage is the possibility to have multiple authentication techniques, which add layered or alternate covert and/or overt security features for a security document or article. It is crucial that the multiple security features do not interfere with each other when it comes to detection and authentication.

Some ferromagnetic components however interfere with the incorporation of other security features, especially in terms of underlying luminescence and/or IR-absorption. This makes the inclusion of inter alia luminescent and/or IR-absorbing security features difficult, as the sensory techniques identifying said features end up having interference from the ferromagnetic component itself. Thus, it is desired to incorporate ferromagnetic pigments which are non-luminescent and/or show minimal or no IR-absorption, while maintaining the possibility to reliably authenticate the security document and/or article.

Other aspects that need to be considered is the homogenous incorporation of the ferromagnetic pigments in the ink composition, thereby providing stability as well as the ability to incorporate the pigments in a wide variety of ink compositions and backward compatibility with standard magnetic readers. It is also desirable to provide detection and authentication possibility at low costs by using standard off-the-shelf magnetic detection means and the ability to perform the detection and authentication operations at a distance and high speed.

Therefore, a need remains for stable and reliable security ink compositions providing strong magnetic detection and authentication capabilities, while interfering minimally in the incorporation of additional security features.

Accordingly, it is an object of the present invention to overcome the deficiencies of the prior art.

### SUMMARY

In one aspect the invention relates to security ink composition comprising at least one non-luminescent undoped Y₃Fe₅₋ₓMₓO₁₂-based pigment,

wherein x fulfils the condition 0≤x≤1.25;
M is selected from a group consisting of aluminum, gallium, calcium and mixtures thereof; and
wherein an applied, preferably printed, at least one machine-readable security feature derived from said security ink composition, after drying and/or curing, has an integrated magnetic susceptibility of at least about 200×10⁻¹²m³ and presents a ferromagnetic resonance (FMR) signature for authentication purposes.

In another aspect the invention relates to a machine-readable security feature comprising at least one security ink composition described herein.

In yet another aspect the invention relates to a security document or article comprising at least one machine-readable security feature described herein.

In another aspect the invention is directed to a method for authenticating a security document or article comprising the steps of:
a) providing a security document or article comprising at least one machine-readable security feature as described herein;
b) defining at least one region of said security document or article containing said at least one machine-readable security feature for the purpose of FMR signal detection;
c) detecting and recording the FMR spectrum of the at least one machine-readable security feature, to provide a recorded FMR spectrum containing enough data points to establish at least one FMR signature;
d) either parametrizing or using directly the recorded FMR spectrum to establish at least one regionally defined FMR signature;
e) comparing the established at least one regionally defined FMR signature from step d) with at least one predefined or expected FMR signature;
f) determining the authenticity of the security document or article based on the comparison operation performed under step e).

### BRIEF DESCRIPTION OF DRAWINGS

The sole Figure exhibits a parametrized FMR spectrum (i.e. a FMR signature) in terms of two parameters, line-width (at half prominence) and line-center field.

### DETAILED DESCRIPTION

The following definitions may be used to interpret the meaning of the terms discussed in the description and/or recited in the claims.

As used herein, the article “a” indicates one as well as more than one and does not necessarily limit its referent noun to the singular.

As used herein, the terms “about” means that the amount or value in question may be the value designated or some other value about the same. The phrases are intended to convey that similar values within a range of ±5% of the indicated value promote equivalent results or effects according to the invention.

As used herein, the term “and/or” or “or/and” means that either all or only one of the elements of said group may be present. For example, “A and/or B” shall mean “only A, or only B, or both A and B”.

As used herein, the term “at least one” is meant to define one or more than one, for example one or two or three.

The term “security document or article” refers to a document or article, respectively, which is usually protected against counterfeiting or fraud by at least one security feature. Examples of security documents include without limitation value documents and value commercial goods.

As used herein, the term “undoped” is meant to define the absence of elements from the lanthanide series of the periodic table. For the sake of clarity, the word absence does not exclude unavoidable residual content of lanthanide elements in negligible amounts.

As used herein, the term “non-luminescent” is meant to define the absence of any type of luminescence in the visible and IR-range in the so defined component.

As used herein, “ferromagnetic resonance (FMR) spectrum” is the recorded spectrum, in at least one defined region of the sample, obtained after detection of a signal by suitable magnetic detection means for the at least one, as described herein, ferromagnetic pigment-containing security ink (composition). Said spectrum may be recorded either at a given radio frequency in magnetic field sweep or at a given magnetic field in a radio frequency sweep. The detection and recording of the FMR spectrum need not be performed over the entire possible range of the field or frequency sweep. Therefore, it is possible to also record the FMR spectrum for a selected part of the range as long as the recorded spectrum provides enough data points for the purpose of establishing the at least one FMR signature as described herein.

As used herein, “ferromagnetic resonance (FMR) signature” is a characteristic representation of the recorded FMR spectrum. It is possible to directly use the recorded FMR spectrum itself for authentication purposes i.e. the recorded spectrum can function as a FMR signature. Alternatively, the FMR spectrum can be parametrized by at least one suitable method. In other words, the FMR spectrum can be used to establish at least one low-dimensional parametric representation, derived from mathematical estimation of defined parameters from the FMR spectrum for the purpose of authentication. In one exemplary form, the FMR signature can be reduced to solely two parameters, namely the line-width and line-center field of the spectrum mode. For more complex spectra another suitable FMR signature can be obtained by projecting the spectrum for example on a suitable functional base (e.g. obtained by Gram Schmidt orthonormalization of several spectra by a principal component analysis). The established at least one regionally defined FMR signature, either FMR spectrum itself or any parametrized form thereof, is the authenticating means for the at least one machine-readable security feature, as is described herein.

The security ink composition or security ink as described herein comprises at least one non-luminescent undoped Y₃Fe₅₋ₓMₓO₁₂-based pigment wherein x fulfils the condition 0≤x≤1.25; and M is selected from a group consisting of aluminum, gallium or calcium and mixtures thereof.

The Y₃Fe₅₋ₓMₓO₁₂-based pigment are also known in the art as Yttrium Iron Garnet pigments or alternatively as YIG pigments. In case of the presence of the element M, the pigments can correspondingly be termed as YI(M)G pigments. As an example, in case of the presence of aluminum the pigment is termed as YI(AI)G garnet pigment. YI(M)G pigments have specific crystal structure assembly, which is influenced by the presence or absence of the element M. These variations in the crystal structure confer different magnetic properties to the pigment, depending on the element M and the value of x.

The element M may be freely selected from aluminum, gallium or calcium and mixtures thereof. The selection of a specific M element does not significantly alter the detected ferromagnetic profile of the Y₃Fe₅₋ₓMₓO₁₂-based pigment i.e. the pigments are able to provide at least one characteristic and unique regionally defined FMR signature irrespective of the selected element M, for authentication purposes. In a preferred embodiment, the element M is aluminum.

While the Y₃Fe₅₋ₓMₓO₁₂-based pigment might not contain any element M (x=0), it is advantageous that the pigment contains at least some amount of element M (value of x=0.01). Thus, it is preferred to have at least some amount of Fe being replaced by the element M in the crystal structure. Even small amounts of element M substituting the Fe ions in the pigment results in favorable signal to noise ratio and makes detection and authentication by means of at least one regionally defined FMR signature of the applied, preferably printed, at least one machine-readable security feature easier.

In preferred embodiments, the value of x in the Y₃Fe₅₋ₓMₓO₁₂-based pigment is 0.01≤x≤1.25, more preferably 0.10≤x≤1.25. In an even more preferred embodiment, the value of x lies in the range 0.25≤x≤1.00. The presence of element M in the above ranges provides optimum signal to noise ratio and FMR detectability profile for the derived at least one machine-readable security feature.

A corresponding measure of the replacement of Fe by element M in Y₃Fe₅₋ₓMₓO₁₂-based pigment can also be described in terms of mol-% replacement of Fe ions with that of element M in the crystal structure. As an example, if the value of x is 0.01, this would translate to 0.2 mol-% replacement of Fe ions by those of element M in the pigment crystal structure. Considering the maximum value of x=1.25, this would correspond to 25 mol-% replacement of Fe ions. Hence, in the described Y₃Fe₅₋ₓMₓO₁₂-based pigment, the Fe ions can be advantageously replaced up to 25 mol-%. A higher amount of substitution of Fe by element M leads to deterioration of properties, especially of integrated magnetic susceptibility. In preferred embodiments, the Fe replacement by element M is between 2 mol-% and 20 mol-%, or between 5 mol-% and 20 mol-%.

The Y₃Fe₅₋ₓMₓO₁₂-based pigment may be incorporated in the security ink compositions described herein up to 40 wt-%, up to 30 wt-% or preferably up to 20 wt-% or even up to 15 wt-%. Due to the easy detectability of the described pigments, only a small amount of pigment may be sufficient to be included in the security ink compositions, depending on the type of the formulated security ink.

Additionally, the use of Y₃Fe₅₋ₓMₓO₁₂-based pigments as described herein provides flexibility to add other colored pigments and tune the color profile of the security ink compositions while maintaining detectability and authentication features, due to the low intrinsic visible color of the pigments itself.

Y₃Fe₅₋ₓMₓO₁₂-based pigments can be obtained by synthetic methods known to a skilled person in the art like mechanical alloying, co-precipitation in emulsion, solid state sintering, spray pyrolysis, microwave hydrothermal synthesis and sol-gel synthesis. One of the commonly used methods of synthesis is also calcination of individual oxides at elevated temperatures.

The security ink composition is applied, preferably printed, to provide at least one machine- readable security feature, which after drying and/or curing has an integrated magnetic susceptibility of at least about 200×10⁻¹²m³ and presents a ferromagnetic resonance (FMR) signature for authentication purposes.

The minimum level of integrated magnetic susceptibility is important to ensure quick and reliable detection of the security features in e.g. ATMs or HSS-machines and to provide detectability with common magnetic detectors. When the value of x is between the previously defined ranges, the pigments provide desirable integrated magnetic susceptibility characteristics for detection of the printed at least one machine-readable security feature, while keeping the amount of pigment used at rather small levels. This provides benefits of cost reduction and process efficiency, especially compared to paramagnetic pigments. When x is >1.25, the integrated magnetic susceptibility may not be high enough to ensure reliable detection.

The authentication of the at least one machine-readable security feature comprising the security ink composition is performed by means of the at least one regionally defined FMR signature. The FMR signature may take the form of the spectrum itself or alternatively at least one mathematically derived parametrized form. For the purpose of authentication of the at least one machine-readable security feature containing single pigment or blend of pigments, as described herein, it is not necessary that the established at least one regionally defined FMR signature match identically or fully with a statistically expected or previously recorded at least one FMR signature. As long as the at least one FMR signature meets the accepted or minimum confidence/tolerance thresholds in the industry, the at least one machine-readable security feature can be classified as authentic.

When a single pigment, as described herein, is included in the security ink composition, depending on the element M and its substitution amount, at least one specific and unique FMR signature can be derived for the pigment from the recorded FMR spectrum. In one form the FMR signature, may be parametrized in terms of two parameters, namely line-width and line-center field. As an example, if the value of x is 1 and element M is aluminum, then the Y₃Fe₅₋ₓMₓO₁₂-based pigment would have a formula Y₃Fe₄AlO₁₂. It is possible to characterize this specific pigment, and thereby the derived machine-readable security feature, in terms of at least one unique FMR signature defined by individual values for line-width and line-center field. It is to be noted however that such a parametrization represents one way of establishing the FMR signature for authentication purposes. It is possible to also use other ways of parametrizing the recorded FMR spectrum i.e. more than two parameters may be derived to establish the FMR signature, depending on the parametrization method or a different parametrization method may be used. It is also possible to use multiple parametrization methods in combination with one another. This allows the possibility to develop a complex set of signatures for the at least one machine- readable security features, broadening the portfolio for authentication purposes.

In another embodiment two pigments as described herein, i.e. a blend, may be included in the security ink composition. In such a case, the two pigments would provide two individual FMR spectra. The two spectra may be combined into a common recorded FMR spectrum, representing the blend of the pigments. The characteristics of the individual and thereby the common FMR spectrum for the mixture depends on the substituted element M, the substitution amount x in each pigment as well as the amount of the pigment in the mixture. As mentioned before for single pigment, the recorded common FMR spectrum itself or at least one parametrized form of the FMR spectrum can be further used. As long as the FMR signature of the blend is different from the signature of the individual pigments, it can serve as the basis for authentication purposes.

In yet another embodiment, an additional non-luminescent undoped Y₃Fe₅₋ₓMₓO₁₂-based pigment, wherein x fulfils the condition 0≤x≤5, preferably 0≤x≤4.99, and M is selected from a group consisting of aluminum, gallium or calcium and mixtures thereof may be included in the security ink composition. Said additional pigment also presents its own specific at least one FMR signature, which is characteristic of the said additional pigment. As described previously, it is also possible to derive at least one regionally defined FMR signature for authentication purposes for such a blend.

The Y₃Fe₅₋ₓMₓO₁₂-based pigments can be incorporated in a variety of ink compositions. Thus, the pigments provide broad flexibility for incorporation into many types of ink compositions. As said pigments provide intense signals, they can be incorporated in lower amounts and do not negatively influence the homogeneity and applicability of security ink compositions.

While it is possible to apply the security ink compositions in processes other than printing (such as coating, spraying, extrusion), the security inks described herein are particularly suitable to be applied onto a substrate such as those described herein by a printing process selected from the group consisting of offset printing processes, intaglio printing processes, screen printing processes, rotogravure processes, flexography processes and inkjet printing processes, especially flextensional inkjet printing, more preferably selected form the group consisting of intaglio printing processes and screen printing processes.

The security inks described herein are oxidative drying security inks, UV-Vis curable security inks, thermal drying security inks, or combinations thereof. However, a skilled person can well formulate the described pigments into other type of ink compositions.

Oxidative drying security inks dry by oxidation in the presence of oxygen, in particular in the presence of the oxygen of the atmosphere. During the drying process, the oxygen combines with one or more components of the ink, converting the ink to a solid state. The oxidative drying intaglio inks described herein comprise one or more driers (also referred in the art as catalysts, siccatives, siccative agents, desiccatives or dessicators) to speed up the oxidation process. Examples of driers include inorganic or organic salts of metal(s), metallic soaps of organic acids, metal complexes and metal complex salts. Suitable salts of metal(s) include salts containing cobalt, calcium, copper, zinc, iron, zirconium, manganese, barium, zinc, strontium, lithium, vanadium and potassium as the cation(s); and halides, nitrates, sulphates, carboxylates like acetates, ethylhexanoates, octanoates and naphtenates or acetoacetonates as the anion(s) such as for example ethylhexanoates of cobalt, manganese and zirconium. Suitable examples of metal complexes and metal complex salts include manganese, vanadium and iron compounds (i.e. manganese complexes, manganese complex salts, vanadium complexes, vanadium complex salts, iron complexes and iron complex salts). When present, the one or more driers used in the oxidative drying intaglio ink described herein are preferably present in a total amount from about 0.01 wt-% to about 10 wt-%, more preferably in a total amount from about 0.1 wt-% to about 5 wt-%, the weight percents being based on the total weight of the oxidative drying intaglio ink.

Oxidative drying offset printing security inks are known in the art as requiring a high viscosity. Typically, security inks suitable for oxidative drying offset printing processes have a viscosity in the range of about 2.5 to about 25 Pa s at 40° C. and 1000 s⁻¹; the viscosities being measured on a Haake Roto-Visco RV1 with a cone 2 cm 0.5°.

As generally known in the art, oxidative drying security inks comprise one or more varnishes. The term “varnish” is also referred in the art as resin, binder or ink vehicle. The drying varnishes described herein are preferably present in the oxidative drying security inks described herein in an amount from about 10 to about 90 wt-%, the weight percents being based on the total weight of the oxidative drying security inks. The one or more varnishes for the oxidative drying security inks described herein are preferably selected form the group consisting of polymers comprising unsaturated fatty acid residues, saturated fatty acids residues and mixtures thereof, as generally known in the art. Preferably the one or more varnishes oxidative drying security inks described herein comprise unsaturated fatty acid residues to ensure the air drying properties. Particularly preferred oxidative drying varnishes are resins comprising unsaturated acid groups, even more preferred are resins comprising unsaturated carboxylic acid groups. However, the resins may also comprise saturated fatty acids residues. Preferably the varnishes oxidative drying security inks described herein comprise acid groups, i.e. the oxidative drying varnishes are selected among acid modified resins. The oxidative drying varnishes described herein may be selected from the group consisting of alkyd resins, vinyl polymers, polyurethane resins, hyperbranched resins, rosin-modified maleic resins, rosin-modified phenol resins, rosin esters, petroleum resin-modified rosin esters, petroleum resin-modified alkyd resins, alkyd resin- modified rosin/phenol resins, alkyd resin-modified rosin esters, acrylic-modified rosin/phenol resins, acrylic-modified rosin esters, urethane-modified rosin/phenol resins, urethane-modified rosin esters, urethane-modified alkyd resins, epoxy-modified rosin/phenol resins, epoxy-modified alkyd resins, terpene resins nitrocellulose resins, polyolefins, polyamides, acrylic resins and combinations or mixtures thereof. Polymers and resins are herein interchangeably used.

Saturated and unsaturated fatty acid compounds may be obtained from natural and/or artificial sources. Natural sources include animal sources and/or plant sources. Animal sources may comprise animal fat, butter fat, fish oil, lard, liver fats, tuna fish oil, sperm whale oil and/or tallow oil. Plant sources may comprise oils such as vegetable oils and/or non-vegetable oils. Examples of plant oils include without limitation bitter gourd, borage, calendula, canola, castor, china wood, coconut, conifer seed, corn, cottonseed, dehydrated castor, flaxseed, grape seed, Jacaranda mimosifolia seed, linseed oil, palm, palm kernel, peanut, pomegranate seed, rapeseed, safflower, snake gourd, soya (bean), sunflower, tall, tung and wheat germ. Artificial sources include distilled tall oil and/or chemical or biochemical synthesis methods. Suitable fatty acids also include myristoleic acid (C₁₄H₂₆O₂, CAS No 544-64-9), palmitoleic acid (C₁₆H₃₀O₂, CAS No 373-49-9), oleic acid (C₁₈H₃₄O₂, CAS No 112-80-1), α-eleostearic acid (C₁₈H₃₀O₂, CAS No 506-23-0), licanic acid (C₁₈H₂₈O₃, CAS No 623-99-4), linoleic acid (C₁₈H₃₂O₂, CAS No 60-33-3), linolenic acid (C₁₈H₃₀O₂, CAS No 463-40-1), stearidonic acid (C₁₈H₂₈O₂, CAS No 20290-75-9), arachidonic acid (C₂₀H₃₂O₂, CAS No 506-32-1), ricinoleic acid (C₁₈H₃₄O₃, CAS No 141-22-0), erucic acid (C₂₂H₄₂O₂, CAS No 112-86-7), gadoleic acid (C₂₀H₃₈O₂, CAS No 29204-02-2), clupanodonic acid (C₂₂H₃₄O₂, CAS No 24880-45-3), nisinic acid (C₂₄H₃₆O₂, CAS No 68378-49-4) and mixtures thereof. Those fatty acids are typically used in the form of mixtures of fatty acids derived from natural or synthetic oils.

The oxidatively drying security inks described herein may further comprise one or more antioxidants such as those known by people skilled in the art. Suitable antioxidants include without limitation alkyl phenols, hindered alkyl phenols, alkylthiomethyl-phenols, eugenol, secondary amines, thioether, phosphites, phosphonites, dithiocarbamates, gallates, malonates, propionates, acetates and other esters, carboxamides, hydroquinones, ascorbic acid, triazines, benzyl compounds as well as tocopherols and analogue terpenes. Such antioxidants are commercially available for example from the sources disclosed in WO 02/100 960. Hindered alkyl phenols are phenols having at least one or two alkyl groups ortho to the phenolic hydroxyl. One, preferably both, alkyl groups ortho to the phenolic hydroxyl are preferably secondary or tertiary alkyl, most preferred tertiary alkyl, especially tert-butyl, tert-amyl or 1,1,3,3-tetramethylbutyl. Preferred antioxidants are hindered alkyl phenols and especially, 2-tert-butyl-hydroquinone, 2,5-di-tert-butyl-hydroquinone, 2-tert-butyl-p-cresol and 2,6-di-tert-butyl-p-cresol. When present, the one or more antioxidants are present in an amount from about 0.05 to about 3 wt-%, the weight percents being based on the total weight of the oxidatively drying security ink.

The oxidatively drying security inks described herein may further comprise one or more waxes preferably selected from the group consisting of synthetic waxes, petroleum waxes and natural waxes. Preferably the one or more waxes are selected from the group consisting of microcrystalline waxes, paraffin waxes, polyethylene waxes, fluorocarbon waxes, polytetrafluoroethylene waxes, Fischer-Tropsch waxes, silicone fluids, beeswaxes, candelilla waxes, montan waxes, carnauba waxes and mixtures thereof. When present, the one or more waxes are preferably present in an amount from about 0.1 to about 15 wt-%, the weight percents being based on the total weight of the oxidatively drying security ink.

According to an embodiment, the oxidatively drying security inks described herein are oxidative drying intaglio printing security inks, wherein said oxidative drying intaglio printing security inks comprise the one or more driers described herein, the one or more varnishes described herein and the optional additives or ingredients described herein.

The at least one machine-readable security features described herein may be preferably prepared through an intaglio printing process (also referred in the art as engraved copper plate printing and engraved steel die printing), which is capable of depositing a sufficiently high amount of machine-readable material on the substrate so as to allow for its detection and sensing. Intaglio printing processes refer to printing methods used in particular in the field of security documents. The intaglio printing process is known to be the most consistent and high-quality printing process for producing fine tapering lines and is therefore the printing technology of choice for fine design in the field of security documents, in particular banknotes and stamps. In particular, one of the distinguishing features of the intaglio printing process is that the layer thickness of the ink transferred to the substrate may be varied from a few micrometers to several tens of micrometers by using correspondingly shallow or deep engravings on the intaglio printing device. As mentioned hereabove, the layer thickness of intaglio printed security features thus allow a sufficiently high amount of machine-readable material on the substrate for its detection and sensing.

Intaglio inks or specifically oxidative drying intaglio printing security inks are known in the art as requiring a high viscosity. Typically, security inks suitable for (oxidative drying) intaglio printing processes have a viscosity in the range of about 3 to about 60 Pa s at 40 ° C. and 1000 s⁻¹ using a Haake Roto-Visco RV1, rotational rheometer using a cone plate of 20 mm diameter and a 0.5° geometry, truncated at 25 μm.

The oxidative drying intaglio printing security inks described herein may further comprise one or more surfactants, particularly hydrophilic macromolecular surfactants such as those described e.g. in EP 0340163 B1. The role of the optional surfactants is to help wiping off the excess of ink present on the printing cylinder just before contacting said printing cylinder with the substrate. This process of wiping off the excess of ink is part of any high-speed, industrial intaglio printing process and is carried out using a tissue or a paper roll (“calico”), or a polymer wiping cylinder and a cleansing water-based solution (“wiping solution”). In this case, the optional surfactants are used to emulsify the excess of ink in the cleansing solution. Said surfactants may be nonionic, anionic or cationic as well as zwitterionic ones. In the case of hydrophilic macromolecular surfactants, the functional groups are for example carboxylic or sulfonic acid groups, hydroxyl groups, ether groups or primary, secondary, tertiary or quaternary amino groups. The acid groups may be neutralized with amines, alcanolamines or preferably inorganic bases, or combinations thereof. Primary, secondary and tertiary amino groups may be neutralized with inorganic or organic acids such as sulfonic acids, formic acid, acetic acid, trifluoroacetic acid and others. Particularly preferred are anionic macromolecular surfactants (AMS), such as those described in EP 2014729 A1.

UV-Vis curable security inks consist of security inks that may be cured UV-visible light radiation. The UV-Vis curable security inks described herein comprise from about 0.1 wt-% to about 20 wt-% of one or more photoinitiators and preferably about 1 wt-% to about 15 wt-%, the weight percents being based on the total weight of the UV-Vis curable security ink.

Preferably, the UV-Vis curable security inks described herein comprise one or more UV curable compounds being monomers and oligomers selected from the group consisting of radically curable compounds and cationically curable compounds. The security inks described herein may be a hybrid system and comprise a mixture of one or more cationically curable compounds and one or more radically curable compounds. Cationically curable compounds are cured by cationic mechanisms typically including the activation by radiation of one or more photoinitiators which liberate cationic species, such as acids, which in turn initiate the curing so as to react and/or cross-link the monomers and/or oligomers to thereby cure the security ink. Radically curable compounds are cured by free radical mechanisms typically including the activation by radiation of one or more photoinitiators, thereby generating radicals which in turn initiate the polymerization so as to cure the security ink.

Preferably, the UV-Vis curable security ink described herein comprises one or more oligomers (also referred in the art as prepolymers) selected from the group consisting of oligomeric (meth)acrylates, vinyl ethers, propenyl ethers, cyclic ethers such as epoxides, oxetanes, tetrahydrofuranes, lactones, cyclic thioethers, vinyl and propenyl thioethers, hydroxyl-containing compounds and mixtures thereof. More preferably, the binder of the UV-Vis curable security ink described herein is prepared from oligomers selected from the group consisting of oligomeric (meth)acrylates, vinyl ethers, propenyl ethers, cyclic ethers such as epoxides, oxetanes, tetrahydrofuranes, lactones and mixtures thereof. Typical examples of epoxides include without limitation glycidyl ethers, β-methyl glycidyl ethers of aliphatic or cycloaliphatic diols or polyols, glycidyl ethers of diphenols and polyphenols, glycidyl esters of polyhydric phenols, 1,4-butanediol diglycidyl ethers of phenolformalhedhyde novolak, resorcinol diglycidyl ethers, alkyl glycidyl ethers, glycidyl ethers comprising copolymers of acrylic esters (e.g. styrene-glycidyl methacrylate or methyl methacrylate-glycidyl acrylate), polyfunctional liquid and solid novolak glycidyl ethers resins, polyglycidyl ethers and poly(β-methylglycidyl) ethers, poly(N-glycidyl) compounds, poly(S-glycidyl) compounds, epoxy resins in which the glycidyl groups or β-methyl glycidyl groups are bonded to hetero atoms of different types, glycidyl esters of carboxylic acids and polycarboxylic acids, limonene monoxide, epoxidized soybean oil, bisphenol-A and bisphenol-F epoxy resins. Examples of suitable epoxides are disclosed in EP 2125713 B1. Suitable examples of aromatic, aliphatic or cycloaliphatic vinyl ethers include without limitation compounds having at least one, preferably at least two, vinyl ether groups in the molecule. Examples of vinyl ethers include without limitation triethylene glycol divinyl ether, 1,4-cyclohexanedimethanol divinyl ether, 4-hydroxybutyl vinyl ether, propenyl ether of propylene carbonate, dodecyl vinyl ether, tert-butyl vinyl ether, tert-amyl vinyl ether, cyclohexyl vinyl ether, 2-ethylhexyl vinyl ether, ethylene glycol monovinyl ether, butanediol monovinyl ether, hexanediol monovinyl ether, 1,4-cyclohexanedimethanol monovinyl ether, diethylene glycol monovinyl ether, ethylene glycol divinyl ether, ethylene glycol butylvinyl ether, butane-1,4-diol divinyl ether, hexanediol divinyl ether, diethylene glycol divinyl ether, triethylene glycol divinyl ether, triethylene glycol methylvinyl ether, tetraethylene glycol divinyl ether, pluriol-E-200 divinyl ether, polytetrahydrofuran divinyl ether-290, trimethylolpropane trivinyl ether, dipropylene glycol divinyl ether, octadecyl vinyl ether, (4-cyclohexyl-methyleneoxyethene)-glutaric acid methyl ester and (4-butoxyethene)-iso-phthalic acid ester. Examples of hydroxy-containing compounds include without limitation polyester polyols such as for example polycaprolactones or polyester adipate polyols, glycols and polyether polyols, castor oil, hydroxy-functional vinyl and acrylic resins, cellulose esters, such as cellulose acetate butyrate, and phenoxy resins. Further examples of suitable cationically curable compounds are disclosed in EP 2125713 B1 and EP 0119425 B1.

According to one embodiment of the present invention, the UV-Vis curable security inks described herein comprise one or more radically curable oligomeric compounds selected from (meth)acrylates, preferably selected from the group consisting of epoxy (meth)acrylates, (meth)acrylated oils, polyester (meth)acrylates, aliphatic or aromatic urethane (meth)acrylates, silicone (meth)acrylates, amino (meth)acrylates, acrylic (meth)acrylates and mixtures thereof. The term “(meth)acrylate” in the context of the present invention refers to the acrylate as well as the corresponding methacrylate. The components of the UV-Vis curable security inks described herein may be prepared with additional vinyl ethers and/or monomeric acrylates such as for example trimethylolpropane triacrylate (TMPTA), pentaerytritol triacrylate (PTA), tripropyleneglycoldiacrylate (TPGDA), dipropyleneglycoldiacrylate (DPGDA), hexanediol diacrylate (HDDA) and their polyethoxylated equivalents such as for example polyethoxylated trimethylolpropane triacrylate, polyethoxylated pentaerythritol triacrylate, polyethoxylated tripropyleneglycol diacrylate, polyethoxylated dipropyleneglycol diacrylate and polyethoxylated hexanediol diacrylate.

Alternatively, the UV-Vis curable security ink described herein is a hybrid ink and may be prepared from a mixture of radically curable compounds and cationically curable compounds such as those described herein.

As mentioned above, UV-Vis curing of a monomer, oligomer requires the presence of one or more photoinitiators and may be effected in a number of ways. As mentioned herein and as known by the man skilled in the art, the UV-Vis curable security ink described herein to be cured and hardened on a substrate comprise such as those described herein one or more photoinitiators optionally with one or more photosensitizers, said one or more photoinitiators and optional one or more photosensitizers being selected according to its/their absorption spectrum/spectra in correlation with the emission spectrum of the radiation source. Depending on the degree of transmission of the electromagnetic radiation through the substrate, hardening of the security ink may be obtained by increasing the irradiation time. However, depending on the substrate material, the irradiation time is limited by the substrate material and its sensitivity to the heat produced by the radiation source.

Depending on the monomers, oligomers or prepolymers used in the UV-Vis curable security ink described herein, different photoinitiators might be used. Suitable examples of free radical photoinitiators are known to those skilled in the art and include without limitation acetophenones, benzophenones, benzyldimethyl ketals, alpha-aminoketones, alpha-hydroxyketones, phosphine oxides and phosphine oxide derivatives, as well as mixtures of two or more thereof. Suitable examples of cationic photoinitiators are known to those skilled in the art and include without limitation onium salts such as organic iodonium salts (e.g. diaryl iodoinium salts), oxonium (e.g. triaryloxonium salts) and sulfonium salts (e.g. triarylsulfonium salts), as well as mixtures of two or more thereof. Other examples of useful photoinitiators can be found in standard textbooks such as “Chemistry & Technology of UV & EB Formulation for Coatings, Inks & Paints”, Volume III, “Photoinitiators for Free Radical Cationic and Anionic Polymerization”, 2nd edition, by J. V. Crivello & K. Dietliker, edited by G. Bradley and published in 1998 by John Wiley & Sons in association with SITA Technology Limited. It may also be advantageous to include a sensitizer in conjunction with the one or more photoinitiators in order to achieve efficient curing. Typical examples of suitable photosensitizers include without limitation isopropyl-thioxanthone (ITX), 1-chloro-2-propoxy-thioxanthone (CPTX), 2-chloro-thioxanthone (CTX) and 2,4-diethyl-thioxanthone (DETX) and mixtures of two or more thereof.

The UV-Vis curable security ink described herein is preferably a UV-Vis curable offset printing security ink, a UV-Vis curable intaglio printing security ink, a UV-Vis curable screen printing security ink, a UV-Vis curable flexography printing security ink, a UV-Vis curable rotogravure printing security ink or a UV-Vis curable inkjet printing security ink, especially flextensional inkjet printing security ink, more preferably a UV-Vis curable intaglio printing security ink, a UV-Vis curable screen printing security ink, a UV-Vis curable flexography printing security ink, a UV-Vis curable rotogravure printing security ink or a UV-Vis curable flextensional inkjet printing security ink.

According to an embodiment, the UV-Vis curable security inks described herein are UV-Vis curable offset printing security inks, wherein said UV-Vis curable offset printing security inks comprise the one or more photoinitiators described herein, the one or more UV curable compounds being monomers and oligomers described herein and the optional additives or ingredients described herein.

According to an embodiment, the UV-Vis curable security inks described herein are UV-Vis curable intaglio printing security inks, wherein said UV-Vis curable intaglio printing security inks comprise the one or more photoinitiators described herein, the one or more UV curable compounds being monomers and oligomers described herein and the optional additives or ingredients described herein.

UV-Vis curable offset printing security inks are known in the art as requiring a high viscosity. Typically, security inks suitable for UV-Vis curable printing processes have a viscosity in the range of about 2.5 to about 25 Pa s at 40° C. and 1000 s⁻¹; the viscosities being measured on a Haake Roto-Visco RV1 with a cone 2 cm 0.5°.

UV-Vis curable intaglio printing security inks are known in the art as requiring a high viscosity. Typically, security inks suitable for intaglio printing processes typically have a viscosity in the range of about 3 to about 60 Pa s at 40° C. and 1000 s⁻¹ using a Haake Roto-Visco RV1, rotational rheometer using a cone plate of 20 mm diameter and a 0.5° geometry, truncated at 25 μm.

Examples of UV-Vis curable intaglio printing security inks are described in WO 2021/018771 A1, disclosure of which is incorporated herein by reference.

According to an embodiment, the UV-Vis curable security inks described herein are UV-Vis curable screen printing security inks, wherein said UV-Vis curable screen printing security inks comprise the one or more photoinitiators described herein, the one or more UV curable compounds being monomers and oligomers described herein and the optional additives or ingredients described herein.

Screen printing (also referred in the art as silkscreen printing) is a stencil process whereby an ink is transferred to a surface through a stencil supported by a fine fabric mesh of silk, synthetic fibers or metal threads stretched tightly on a frame. The pores of the mesh are block-up in the non-image areas and left open in the image area, the image carrier being called the screen. Screen printing might be flat-bed or rotary. During printing, the frame is supplied with the ink which is flooded over the screen and a squeegee is then drawn across it, thus forcing the ink through the open pores of the screen. At the same time, the surface to be printed is held in contact with the screen and the ink is transferred to it. Screen printing is further described for example in The Printing ink manual, R.H. Leach and R.J. Pierce, Springer Edition, 5^{th} Edition, pages 58-62 and in Printing Technology, J. M. Adams and P.A. Dolin, Delmar Thomson Learning, 5^{th} Edition, pages 293-328.

Screen printing or specifically UV-Vis curable screen printing security inks are known in the art as requiring a low viscosity. Typically, security inks suitable for screen printing processes have a viscosity in the range of about 0.05 to about 5 Pa s at 25°C. using a Brookfield machine (model “DV-I Prime”, small sample adapter, spindle S27 at 100 or 50 rpm).

Various types of suitable screen printing ink compositions are described in WO 2021/175907 A1 and WO2020/169316 A1, disclosure of which is incorporated herein by reference. Especially suitable screen-printing ink compositions are based on hybrid (cationic/radical), radical curing mechanisms and solvent based.

According to an embodiment, the UV-Vis curable security inks described herein are UV-Vis curable flexography printing security inks, wherein said wherein UV-Vis curable flexography printing security inks comprise the one or more photoinitiators described herein, the one or more UV curable compounds being monomers and oligomers described herein and the optional additives or ingredients described herein.

Flexography printing methods preferably use a unit with a chambered doctor blade, an anilox roller and plate cylinder. The anilox roller advantageously has small cells whose volume and/or density determines the protective varnish application rate. The chambered doctor blade lies against the anilox roller, filling the cells and scraping off surplus protective varnish at the same time. The anilox roller transfers the ink to the plate cylinder which finally transfers the ink to the substrate. Plate cylinders can be made from polymeric or elastomeric materials. Polymers are mainly used as photopolymer in plates and sometimes as a seamless coating on a sleeve. Photopolymer plates are made from light-sensitive polymers that are hardened by ultraviolet (UV) light. Photopolymer plates are cut to the required size and placed in an UV light exposure unit. One side of the plate is completely exposed to UV light to harden or cure the base of the plate. The plate is then turned over, a negative of the job is mounted over the uncured side and the plate is further exposed to UV light. This hardens the plate in the image areas. The plate is then processed to remove the unhardened photopolymer from the non-image areas, which lowers the plate surface in these non-image areas. After processing, the plate is dried and given a post-exposure dose of UV light to cure the whole plate. Preparation of plate cylinders for flexography is described in Printing Technology, J. M. Adams and P.A. Dolin, Delmar Thomson Learning, 5^{th} Edition, pages 359-360.

UV-Vis curable flexography printing security inks are known in the art as requiring a low viscosity. Typically, security inks suitable for flexography processes have a viscosity in the range of about 0.01 to about 1 Pa s at 25° C. and 1000 s⁻¹ using a rotational viscosimeter DHR-2 from TA Instruments (cone-plane geometry, diameter 40 mm).

According to an embodiment, the UV-Vis curable security inks described herein are UV-Vis curable rotogravure printing security inks, wherein said UV-Vis curable rotogravure printing security inks comprise the one or more photoinitiators described herein, the one or more UV curable compounds being monomers and oligomers described herein and the optional additives or ingredients described herein.

As known by those skilled in the art, the term rotogravure refers to a printing process which is described for example in “Handbook of print media”, Helmut Kipphan, Springer Edition, page 48. Rotogravure is a printing process wherein image elements are engraved into the surface of the cylinder. The non-image areas are at a constant original level. Prior to printing, the entire printing plate (non-printing and printing elements) is inked and flooded with ink. Ink is removed from the non-image by a wiper or a blade before printing, so that ink remains only in the cells. The image is transferred from the cells to the substrate by a pressure typically in the range of 2 to 4 bars and by the adhesive forces between the substrate and the ink. The term rotogravure does not encompass intaglio printing processes (also referred in the art as engraved steel die or copper plate printing processes) which rely for example on a different type of ink.

UV-vis curable rotogravure printing security inks are known in the art as having a low viscosity. Typically, security inks suitable for rotogravure printing processes have a viscosity in the range of about 0.01 to about 0.5 Pas at 25° C. and 1000 s⁻¹ using a rotational viscosimeter DHR-2 from TA Instruments (cone-plane geometry, diameter 40 mm).

According to an embodiment, the UV-Vis curable security inks described herein are UV-Vis curable flextensional inkjet printing security inks, wherein said UV-Vis curable flextensional inkjet printing security inks comprise the one or more photoinitiators described herein, the one or more UV curable compounds being monomers and oligomers described herein and the optional additives or ingredients described herein.

Flextensional inkjet printing is an inkjet printing using a flextensional inkjet print head structure. Usually, flextensional transducers include a body or substrate, a flexible membrane having an orifice defined therein, and an actuator. The substrate defines a reservoir for holding a supply of flowable material and the flexible membrane has a circumferential edge supported by the substrate. The actuator may either be piezoelectric (i.e. it includes a piezoelectric material which deforms when an electrical voltage is applied), or thermally activated, such as described for example in U.S. Pat. No. 8,226,213. As such, when the material of the actuator deforms, the flexible membrane deflects causing a quantity of flowable material to be ejected from the reservoir through the orifice. Flextensional print head structures are described in U.S. Pat. No. 5,828,394, wherein a fluid ejector is disclosed which includes one wall including a thin elastic membrane having an orifice defining a nozzle and elements responsive to electrical signals for deflecting the membrane to eject drops of fluid from the nozzle. Flextensional print head structures are described in U.S. Pat. No. 6,394,363, wherein the disclosed uses for example excitation of the surface layers incorporating nozzles which are arranged over one surface layer with addressability, forming a liquid projection array, capable of operation at high frequencies with a wide range of liquids. Flextensional print head structures are also described in U.S. Pat. No. 9,517,622, which describes a liquid droplet forming apparatus comprising a film member configured to be vibrated so as to eject liquid held in a liquid holding unit, wherein a nozzle is formed in the film member. Further it is provided a vibrating unit to vibrate the film member; and a driving unit to selectively apply an ejection waveform and a stirring waveform to the vibrating unit. Flextensional print head structures are also described in U.S. Pat. No. 8,226,213 which describes a method of actuating a thermal bend actuator having an active beam fused to a passive beam. The method comprises passing an electrical current through the active beam so as to cause thermoelastic expansion of the active beam relative to the passive beam and bending of the actuator.

UV-Vis curable flextensional inkjet printing security inks are known in the art as having a very low viscosity. Typically, security inks suitable for flextensional inkjet printing processes have a viscosity less than about 100 mPa s, when measured at 25° C. and 1000 s⁻¹ using a rotational viscosimeter DHR-2 from TA Instruments, having a cone-plane geometry and a diameter of 40 mm.

Thermal or heat drying security inks consist of security inks which are dried by hot air, infrared or by a combination thereof. Thermal drying security inks typically consist of about 10 wt-% to about 90 wt-% solid content that remains on the printed substrate and about 10 wt-% to about 90 wt-% of one or more solvents which are evaporated as a result of drying, the one or more solvents being selected from the group consisting of organic solvents, water and mixtures thereof.

Preferably, the organic solvents described herein are selected from the group consisting of alcohols (such as ethanol), ketones (such as methyl ethyl ketone), esters (such as ethyl acetate or propyl acetate), glycol ethers (such as DOWANOL™ DPM), glycol ether esters (such as butyl glycol acetate) and mixtures thereof.

According to one embodiment, the thermal drying security inks described herein consist of water-based thermal drying security inks comprising one or more resins selected from the group consisting of polyester resins, polyether resins, polyurethane resins (e.g. carboxylated polyurethane resins), polyurethane alkyd resins, polyurethane-acrylate resins, polyacrylates resins, polyetherurethane resins, styrene acrylate resins, polyvinylalcohol resins, poly(ethylene glycol) resins, polyvinylpyrrolidone resins, polyethyleneimine resins, modified starches, cellulose esters or ethers (such as cellulose acetate and carboxymethyl cellulose), copolymers and mixtures thereof.

According to an embodiment, the thermal drying security inks described herein consist of solvent-based thermal drying security inks comprising one or more resins selected from the group consisting of nitrocelluloses, methyl celluloses, ethyl celluloses, cellulose acetates, polyvinylbutyrals, polyurethanes, polyacrylates, polyamides, polyesters, polyvinyl acetates, rosin modified phenolic resins, phenolic resins, maleic resins, styrene-acrylic resins, polyketone resins, and mixtures thereof.

Suitable thermal drying security ink compositions are described in WO 2020/239740 A1 and WO2019/219250 A1, disclosure of which is incorporated herein by reference.

As mentioned hereabove, dual-cure or dual-hardening security inks may be used for printing the at least one machine-readable security feature described herein, wherein these security inks combine two drying or curing mechanisms.

Examples of dual-cure or dual-hardening security inks include oxidative drying mechanisms and UV-Vis curing mechanisms such as for example intaglio printing security inks, described e.g. in EP 2 171 007 B1.

Examples of dual-cure or dual-hardening security inks include oxidative drying mechanisms and thermal drying mechanisms such as for example screen printing security inks, rotogravure printing security inks and flextensional inkjet printing security inks.

Examples of dual-cure or dual-hardening security inks include UV-Vis curing mechanisms and thermal drying mechanisms such as for example screen printing security inks and rotogravure inks. Typically, such these dual-cure or dual-hardening security inks are similar to UV-Vis curable security inks but include a volatile part constituted by water and/or one or more organic solvents. These volatile constituents are evaporated first using hot air and/or IR driers, and UV-Vis curing is then completing the hardening process. The composition of such inks is described e.g. in WO 2019/002046 A1.

The security inks or security ink compositions described herein may further comprise one or more fillers and/or extenders preferably selected from the group consisting of talcs, micas (e.g. muscovites), montmorillonites, bentonites, wollastonites, halloysites, calcined clays, china clays, carbonates (e.g. calcium carbonate, magnesium carbonate), silicates (e.g. magnesium silicate, aluminum silicate), vermiculites, amorphous silica (e.g. fumed silica, precipitated silica, silica flour), wood flours (sawdust), natural fibers, synthetic fibers (such as carbon fibers or carbon nanotubes) and mixtures thereof; preferably selected from the group consisting of talcs, micas, wollastonites, calcined clays, carbonates, amorphous silica and mixtures thereof.

When present in an intaglio ink, the one or more fillers or extenders are preferably present in a total amount from about 0.1 wt-% to about 50 wt-%, more preferably from about 20 wt-% to about 40 wt-%, the weight percents being based on the total weight of the oxidative drying intaglio ink. When present in a rotogravure, flexography or screen printing ink, then one or more fillers or extenders are preferably present in a total amount from about 0.05 wt-% to about 20 wt-%, more preferably from about 0.1 wt-% to about 10 wt-%, even more preferably between about 0.5 wt-% and about 5 wt-%, the weight percents being based on the total weight of the rotogravure, flexography or screen printing ink.

The security inks described herein may further comprise comprises one or more coloring components selected from the group consisting of optically variable pigments, color constant pigments, color constant dyes and mixtures thereof, preferably selected from the group consisting of color constant organic pigments, color constant inorganic pigments and mixtures thereof.

Dyes suitable for security ink compositions are known in the art and are preferably selected from the group comprising reactive dyes, direct dyes, anionic dyes, cationic dyes, acid dyes, basic dyes, food dyes, metal-complex dyes, solvent dyes and mixtures thereof. Typical examples of suitable dyes include without limitation coumarines, cyanines, oxazines, uranines, phtalocyanines, indolinocyanines, triphenylmethanes, naphtalocyanines, indonanaphtalo-metal dyes, anthraquinones, anthrapyridones, azo dyes, rhodamines, squarilium dyes, croconium dyes. Typical examples of dyes suitable for the present invention include without limitation C.I. Acid Yellow 1, 3, 5, 7, 11, 17, 19, 23, 25, 29, 36, 38, 40, 42, 44, 49, 54, 59, 61, 70, 72, 73, 75, 76, 78, 79, 98, 99, 110, 111, 121, 127, 131, 135, 142, 157, 162, 164, 165, 194, 204, 236, 245; C.I. Direct Yellow 1, 8, 11, 12, 24, 26, 27, 33, 39, 44, 50, 58, 85, 86, 87, 88, 89, 98, 106, 107, 110, 132, 142, 144; C.I. Basic Yellow 13, 28, 65; C.I. Reactive Yellow 1, 2, 3, 4, 6, 7, 11, 12, 13, 14, 15, 16, 17, 18, 22, 23, 24, 25, 26, 27, 37, 42; C.I. Food Yellow 3, 4; C.I. Acid Orange 1, 3, 7, 10, 20, 76, 142, 144; C.I. Basic Orange 1, 2, 59; C.I. Food Orange 2; C.I. Orange B; C.I. Acid Red 1, 4, 6, 8, 9, 13, 14, 18, 26, 27, 32, 35, 37, 42, 51, 52, 57, 73, 75, 77, 80, 82, 85, 87, 88, 89, 92, 94, 97, 106, 111, 114, 115, 117, 118, 119, 129, 130, 131, 133, 134, 138, 143, 145, 154, 155, 158, 168, 180, 183, 184, 186, 194, 198, 209, 211, 215, 219, 221, 249, 252, 254, 262, 265, 274, 282, 289, 303, 317, 320, 321, 322, 357, 359; C.I. Basic Red 1, 2, 14, 28; C.I. Direct Red 1, 2, 4, 9, 11, 13, 17, 20, 23, 24, 28, 31, 33, 37, 39, 44, 46, 62, 63, 75, 79, 80, 81, 83, 84, 89, 95, 99, 113, 197, 201, 218, 220, 224, 225, 226, 227, 228, 229, 230, 231, 253; C.I. Reactive Red 1, 2, 3, 4, 5, 6, 7, 8, 11, 12, 13, 15, 16, 17, 19, 20, 21, 22, 23, 24, 28, 29, 31, 32, 33, 34, 35, 36, 37, 38, 39, 40, 41, 42, 43, 45, 46, 49, 50, 58, 59, 63, 64, 108, 180; C.I. Food Red 1, 7, 9, 14; C.I. Acid Blue 1, 7, 9, 15, 20, 22, 23, 25, 27, 29, 40, 41, 43, 45, 54, 59, 60, 62, 72, 74, 78, 80, 82, 83, 90, 92, 93, 100, 102, 103, 104, 112, 113, 117, 120, 126, 127, 129, 130, 131, 138, 140, 142, 143, 151, 154, 158, 161, 166, 167, 168, 170, 171, 182, 183, 184, 187, 192, 193, 199, 203, 204, 205, 229, 234, 236, 249, 254, 285; C.I. Basic Blue 1, 3, 5, 7, 8, 9, 11, 55, 81; C.I. Direct Blue 1, 2, 6, 15, 22, 25, 41, 71, 76, 77, 78, 80, 86, 87, 90, 98, 106, 108, 120, 123, 158, 160, 163, 165, 168, 192, 193, 194, 195, 196, 199, 200, 201, 202, 203, 207, 225, 226, 236, 237, 246, 248, 249; C.I. Reactive Blue 1, 2, 3, 4, 5, 7, 8, 9, 13, 14, 15, 17, 18, 19, 20, 21, 25, 26, 27, 28, 29, 31, 32, 33, 34, 37, 38, 39, 40, 41, 43, 44, 46, 77; C.I. Food Blue 1, 2; C.I. Acid Green 1, 3, 5, 16, 26, 104; C.I. Basic Green 1, 4; C.I: Food Green 3; C.I. Acid Violet 9, 17, 90, 102, 121; C.I. Basic Violet 2, 3, 10, 11, 21; C.I. Acid Brown 101, 103, 165, 266, 268, 355, 357, 365, 384; C.I. Basic Brown 1; C.I. Acid Black 1, 2, 7, 24, 26, 29, 31, 48, 50, 51, 52, 58, 60, 62, 63, 64, 67, 72, 76, 77, 94, 107, 108, 109, 110, 112, 115, 118, 119, 121, 122, 131, 132, 139, 140, 155, 156, 157, 158, 159, 191, 194; C.I. Direct Black 17, 19, 22, 32, 39, 51, 56, 62, 71, 74, 77, 94, 105, 106, 107, 108, 112, 113, 117, 118, 132, 133, 146, 154, 168; C.I. Reactive Black 1, 3, 4, 5, 6, 8, 9, 10, 12, 13, 14, 18, 31; C.I. Food Black 2; C.I. Solvent Yellow 19, C.I. Solvent Orange 45, C.I. Solvent Red 8, C.I. Solvent Green 7, C.I. Solvent Blue 7, C.I. Solvent Black 7; C.I. Disperse Yellow 3, C.I. Disperse Red 4, 60, C.I. Disperse Blue 3, and metal azo dyes disclosed in U.S. Pat. Nos. 5,074,914, 5,997,622, 6,001,161, JP 02-080470, JP 62-190272, JP 63-218766. Suitable dyes for the present invention may be infrared absorbing dyes or luminescent dyes. When present, the one or more dyes described herein are preferably present in a total amount from about 1 wt-%, to about 20 wt-%, the weight percents being based on the total weight of the security ink composition.

Typical examples of organic and inorganic pigments include without limitation C.I. Pigment Yellow 12, C.I. Pigment Yellow 42, C.I. Pigment Yellow 93, C.I. Pigment 109, C.I. Pigment Yellow 110, C.I. Pigment Yellow 147, C.I. Pigment Yellow 173, C.I. Pigment Orange 34, C.I. Pigment Orange 48, C.I. Pigment Orange 49, C.I. Pigment Orange 61, C.I. Pigment Orange 71, C.I. Pigment Orange 73, C.I. Pigment Red 9, C.I. Pigment Red 22, C.I. Pigment Red 23, C.I. Pigment Red 67, C.I. Pigment Red 122, C.I. Pigment Red 144, C.I. Pigment Red 146, C.I. Pigment Red 170, C.I. Pigment Red 177, C.I. Pigment Red 179, C.I. Pigment Red 185, C.I. Pigment Red 202, C.I. Pigment Red 224, C.I. Pigment Brown 6, C.I. Pigment Brown 7, C.I. Pigment Red 242, C.I. Pigment Red 254, C.I. Pigment Red 264, C.I. Pigment Brown 23, C.I. Pigment Blue 15, C.I. Pigment Blue 15:3, C.I. Pigment Blue 60, C.I. Pigment Violet 19, C.I. Pigment Violet 23, C.I. Pigment Violet 32, C.I. Pigment Violet 37, C.I. Pigment Green 7, C.I. Pigment Green 36, C.I. Pigment Black 7, C.I. Pigment Black 11, Pigment Black 31, Pigment Black 32, C. I. Pigment White 4, C.I Pigment White 6, C.I. Pigment White 7, C.I. Pigment White 21, C. I. Pigment White 22, antimony yellow, lead chromate, lead chromate sulfate, lead molybdate, ultramarine blue, cobalt blue, manganese blue, chrome oxide green, hydrated chrome oxide green, cobalt green, cerium sulfide, cadmium sulfide, cadmium sulfoselenides, zinc ferrite, bismuth vanadate, Prussian blue, mixed metal oxides, azo, azomethine, methine, anthraquinone, phthalocyanine, perinone, perylene, diketopyrrolopyrrole, thioindigo, thiazinindigo, dioxazine, iminoisoindoline, iminoisoindolinone, quinacridone, flavanthrone, indanthrone, anthrapyrimidine and quinophthalone pigments. When present, the inorganic pigments, organic pigments or mixtures thereof described herein are preferably present in a total amount from about 0.1 wt-% to about 45 wt-%, the weight percents being based on the total weight of the security ink composition.

According to one aspect of the present invention, the security ink compositions described herein are optically variable inks and comprise optically variable pigments or a mixture of different optically variable pigments. Optically variable inks may further comprise one or more color constant pigments. Optically variable inks preferably comprise optically variable pigments or a mixture of different optically variable pigments, wherein the optically variable pigments are preferably selected from the group consisting of thin film interference pigments, interference coated pigments, cholesteric liquid crystal pigments and mixtures thereof. When present, the optically variable pigments described herein are included in a total amount between about 5 wt-% and about 40 wt-% and more preferably in a total amount between about 10 wt-% and about 35 wt-%, the weight percents being based on the total weight of the security ink compositions.

The security inks described herein may further comprise one or more machine-readable compounds known in the art. Such machine-readable compounds or taggants or markers may be included for forensic detection purposes. Various devices like (FT)IR spectrometer, fluorimeter/luminescence detector, optical microscope, scanning or tunneling electron microscope, Raman spectrometer may be used for detecting such machine-readable compounds.

Suitable machine-readable IR-absorbing compounds are described in WO 2019/002046 A1, the disclosure of which is incorporated herein by reference.

Suitable machine-readable organic luminescent compounds are described in WO 2011/147587 A1, WO 2012/160182 A1, WO2013/068324 A1, WO 2013/068275 A1, WO 2013/075980 A1, WO 2013/079521 A1, while inorganic luminescent compounds are described in WO 2014/048702 A1, WO 2018/172318 A1, WO 2009/006634 A1, WO 2011/002960 A1, WO 2011/041657 A1. Said references are incorporated herein by reference.

Suitable machine-readable SERS compounds are described in U.S. Pat. No. 5,609,907 A, WO 1998/010289 A1, WO 2010/135354 A1 and WO 2010/135351 A1. Said references are incorporated herein by reference.

Suitable machine-readable compounds that have a specific shape and/or indicia requiring magnification to be observed are described e.g. in US 2012/107 738 A1, US 2009/2017 842 A1, US 2008/236 447 A1, US 2008/107 856 A1, US 2008/088 895 A1, US 7 639 109 B2, US 7 241 489 B2, US 7 645 510 B2 and EP 1 741 757 B1. Said references are incorporated herein by reference.

The security ink described herein may further comprise one or more additives, said one or more additives including without limitation compounds and materials which are used for adjusting physical, rheological and chemical parameters of the security ink such as the consistency (e.g. anti-settling agents and plasticizers), the foaming properties (e.g. antifoaming agents and deaerators), the lubricating properties (waxes), the UV stability (photostabilizers), the adhesion properties, the surface properties (wetting agents, oleophobic and hydrophobic agents), the drying/curing properties (cure accelerators, sensitizers, crosslinkers), etc. Additives described herein may be present in the security inks described herein in amounts and in forms known in the art, including in the form of so-called nano-materials where at least one of the dimensions of the additives is in the range of 1 to 1000 nm.

The present invention further provides methods for producing the security inks described herein and security inks obtained therefrom. The security inks described herein may be prepared by dispersing or mixing the at least one non-luminescent undoped Y₃Fe₅₋ₓMₓO₁₂-based pigment as described herein and all the other ingredients thus forming liquid or pasty inks. When the security inks described herein are oxidatively drying intaglio inks, the one or more oxidative driers are usually added at the end of the dispersion process. When the security inks described herein are UV-VIS curable security inks, the one or more photoinitiators may be added to the composition either during the dispersing or mixing step of all other ingredients or may be added at a later stage, i.e. after the formation of the liquid or pasty inks. Varnishes, binder compounds, monomers, oligomers, resins and additives are typically chosen among those known in the art and as described hereabove and depend on the printing process used to apply the security ink described herein on the substrate described herein.

The security inks described herein are applied on the substrate described herein for producing a at least one machine-readable security feature by coating, spraying, extrusion or a mixture of these application techniques.

In a preferred embodiment a printing process, preferably selected from the group consisting of offset processes, intaglio printing processes, screen printing processes, rotogravure processes, flexography processes and inkjet printing processes, more preferably selected form the group consisting of intaglio printing processes, screen printing processes, rotogravure processes, flexography processes and flextensional inkjet printing processes and still more preferably selected form the group consisting of intaglio printing processes, screen printing processes and rotogravure processes is used for the security ink application.

The present invention further provides methods for producing the at least one machine-readable security features described herein. The method comprises a step a) of applying, preferably by a printing process selected from the group consisting of intaglio printing, screen printing, flexography printing, rotogravure printing and inkjet printing, the security ink described herein onto the substrate described herein.

After step a), a step b) of drying and/or curing the security ink in the presence of UV-VIS radiation and/or air or heat is carried out so as to form the at least one machine-readable security feature described herein on the substrate.

The present invention further provides at least one machine-readable security features made of the security ink described herein on the substrate described herein.

The substrates described herein are preferably selected from the group consisting of papers or other fibrous materials (including woven and non-woven fibrous materials), such as cellulose, paper-containing materials, glasses, metals, ceramics, plastics and polymers, metallized plastics or polymers, composite materials and mixtures or combinations of two or more thereof. Typical paper, paper-like or other fibrous materials are made from a variety of fibers including without limitation abaca, cotton, linen, wood pulp, and blends thereof. As is well known to those skilled in the art, cotton and cotton/linen blends are preferred for banknotes, while wood pulp is commonly used in non-banknote security documents. Typical examples of plastics and polymers include polyolefins such as polyethylene (PE) and polypropylene (PP) including biaxially oriented polypropylene (BOPP), polyamides, polyesters such as poly(ethylene terephthalate) (PET), poly(1,4-butylene terephthalate) (PBT), poly(ethylene 2,6-naphthoate) (PEN) and polyvinylchlorides (PVC). Spunbond olefin fibers such as those sold under the trademark Tyvek® may also be used as substrate. Typical examples of metalized plastics or polymers include the plastic or polymer materials described hereabove having a metal disposed continuously or discontinuously on their surface. Typical example of metals includes, without limitation, aluminum (Al), chromium (Cr), copper (Cu), gold (Au), silver (Ag), alloys thereof and combinations of two or more of the aforementioned metals. The metallization of the plastic or polymer materials described hereabove may be done by an electrodeposition process, a high-vacuum coating process or by a sputtering process. Typical examples of composite materials include without limitation multilayer structures or laminates of paper and at least one plastic or polymer material such as those described hereabove as well as plastic and/or polymer fibers incorporated in a paper-like or fibrous material such as those described hereabove. Of course, the substrate can comprise further additives that are known to the skilled person, such as fillers, sizing agents, whiteners, processing aids, reinforcing or wet strengthening agents, etc.

The present invention further provides security documents comprising the substrate described herein and the at least one machine-readable security feature described herein or security documents comprising more than one of the at least one machine-readable security features described herein. Security documents include without limitation value documents and value commercial goods. Typical example of value documents include without limitation banknotes, deeds, tickets, checks, vouchers, fiscal stamps and tax labels, agreements and the like, identity documents such as passports, identity cards, visas, driving licenses, bank cards, credit cards, transactions cards, access documents or cards, entrance tickets, public transportation tickets or titles and the like. The term “value commercial good” refers to packaging material, in particular for pharmaceutical, cosmetics, electronics or food industry that may be protected against counterfeiting and/or illegal reproduction in order to warrant the content of the packaging like for instance genuine drugs. Example of these packaging material include without limitation labels such as authentication brand labels, tamper evidence labels and seals. Preferably, the security document described herein is selected from the group consisting of banknotes, identity documents, right-conferring documents, driving licenses, credit cards, access cards, transportation titles, vouchers and secured product labels. Alternatively, the security features described herein may be produced onto an auxiliary substrate such as for example a security thread, security stripe, a foil, a decal, a window or a label and consequently transferred to a security document in a separate step. The mentioned substrates, value documents and value commercial goods are exemplary and do not restrict the scope of the invention.

With the aim of further increasing the security level and the resistance against counterfeiting and illegal reproduction of security documents, the substrate described herein may contain printed, coated, or laser-marked or laser-perforated indicia, watermarks, security threads, fibers, planchettes, luminescent compounds, windows, foils, decals, primers and combinations of two or more thereof, provided that these potential additional elements do not negatively interfere with the magnetic detectability of the applied, preferably printed, at least one machine-readable security feature.

With the aim of increasing the durability through soiling or chemical resistance and cleanliness and thus the circulation lifetime of security documents or with the aim of modifying their aesthetical appearance (e.g. optical gloss), one or more protective layers may be applied on top of the at least one machine-readable security features or security document described herein. When present, the one or more protective layers are typically made of protective varnishes which may be transparent or slightly colored or tinted and may be more or less glossy. Protective varnishes may be radiation curable compositions, thermal drying compositions or any combination thereof. Preferably, the one or more protective layers are made of radiation curable compositions, more preferably UV-Vis curable compositions.

The at least one machine-readable security features described herein may be provided directly on a substrate on which it shall remain permanently (such as for banknote applications). Alternatively, at least one machine-readable security feature may also be provided on a temporary substrate for production purposes, from which the at least one machine-readable security feature is subsequently removed. Thereafter, after hardening/curing of the security ink described herein for the production of the at least one machine-readable security feature, the temporary substrate may be removed from the at least one machine-readable security feature.

Alternatively, in another embodiment an adhesive layer may be present on at least one machine-readable security feature or may be present on the substrate comprising said machine-readable security feature, said adhesive layer being on the side of the substrate opposite to the side where the machine-readable security feature is provided or on the same side as the machine-readable security feature and on top of the machine-readable security feature. Therefore, an adhesive layer may be applied to the machine-readable security feature or to the substrate, said adhesive layer being applied after the drying or curing step has been completed. Such an article may be attached to all kinds of documents or other articles or items without printing or other processes involving machinery and rather high effort. Alternatively, the substrate described herein comprising the machine-readable security feature described herein may be in the form of a transfer foil, which can be applied to a document or to an article in a separate transfer step. For this purpose, the substrate is provided with a release coating, on which the machine-readable security feature is produced as described herein. One or more adhesive layers may be applied over the so produced drying machine-readable security feature.

Also described herein are substrates, security documents, decorative elements and objects comprising more than one, i.e. two, three, four, etc. at least one machine-readable security feature described herein. Also described herein are articles, in particular security documents, decorative elements or objects, comprising the at least one machine-readable security feature described herein.

As mentioned hereabove, the at least one machine-readable security feature described herein may be used for protecting and authenticating a security document or decorative elements.

Typical examples of decorative elements or objects include without limitation luxury goods, cosmetic packaging, automotive parts, electronic/electrical appliances, furniture and fingernail articles.

The at least one machine-readable security feature comprising the at least one non-luminescent undoped Y₃Fe₅₋ₓMₓO₁₂-based pigment described herein may consist of an indicium, wherein said indicium refers to codes (like a bar code or a QR-code), symbols, alphanumeric symbols, motifs, geometric patterns, letters, words, numbers, logos, drawings, portraits and combinations thereof.

According to one embodiment, the substrates, security documents or articles described herein comprise a combined security feature made of a first area consisting of the at least one machine-readable security feature described herein, derived from the security ink comprising the at least one non-luminescent undoped Y₃Fe₅₋ₓMₓO₁₂-based pigment described herein, and a second area wherein said non-luminescent undoped pigment is not present. The first and second areas may be adjacent, partially overlapping each other or spaced apart. The first and second area may build an image and may be made of inks that comprise one or more compounds (e.g. pigments or dyes) absorbing in the visible region of the electromagnetic spectrum, said compounds being selected in such a way that, preferably, both areas are color matched in the visible spectrum.

Another embodiment of the invention is directed to a method for authenticating a security document or article comprising the steps of:
a) providing a security document or article comprising at least one machine-readable security feature as described herein;
b) defining at least one region of said security document or article containing said at least one machine-readable security feature for the purpose of FMR signal detection;
c) detecting and recording the FMR spectrum of the at least one machine-readable security feature, to provide a recorded FMR spectrum containing enough data points to establish at least one FMR signature;
d) either parametrizing or using directly the recorded FMR spectrum to establish at least one regionally defined FMR signature;
e) comparing the established at least one regionally defined FMR signature from step d) with at least one predefined or expected FMR signature;
f) determining the authenticity of the security document or article based on the comparison operation performed under step e).

A security document or article comprising the at least one machine-readable security feature as described herein is subjected to detection of the ferromagnetic signal characteristics of the at least one non-luminescent undoped Y₃Fe₅₋ₓMₓO₁₂-based pigment present in the machine-readable security feature. The detection is performed at a predefined region of the security document or article, where the security ink composition has been applied, preferably printed, to form the machine-readable security feature. To determine authenticity, the established regionally defined at least one FMR signature is to be compared to that which is expected at the defined region and not another region of the security document or article. Thus, if the established FMR signature is either not determined at the defined region or is observed at a non-defined region, the sample is classified as non-authentic.

The FMR detection may be performed by systems based on known technologies like off-the- shelf microwave electronic components and permanent magnet arrangements. Specifically, the detection may be carried out by a frequency sweep with IQ demodulator-based impedance measurement system with a fixed magnet, a locking oscillator-based detector with a fixed magnet or a discrete matrix of fixed frequency IQ demodulator-based impedance measurement system with a fixed magnet. It is well within a skilled person's purview to use other means of detection. The detected FMR signal may be then recorded and stored using computerized means.

After detection and recording of the FMR spectrum as described herein, at least one regionally defined FMR signature is derived from the recorded spectrum. As described herein, the spectrum itself or alternatively at least one suitable mathematically derived parametrized representation of the spectrum can be obtained. Thus, the FMR spectrum leads to the generation of at least one regionally defined FMR signature in an appropriate form, for authentication purposes.

For a specific machine-readable security feature resulting from at least one non-luminescent undoped Y₃Fe₅₋ₓMₓO₁₂-based pigment as well as the blend of said individual pigments included in the security ink composition, it is possible to derive a statiscally expected ‘reference’ signature or signatures against which the established regionally defined FMR signature(s) can be compared. Another method involves comparing the established regionally defined FMR signature against a previously measured and stored at least one regionally defined FMR signature for the same pigment or blend of pigments. Irrespective of the method of comparison, the generated regionally defined at least one FMR signature is checked for conformity or compared against at least one expected FMR signature. Such a comparison need not yield a perfect match but only need satisfy the accepted or minimum tolerated industry-defined thresholds or confidence limits to classify the at least one machine-readable security feature as genuine (i.e. authentic) or not. In other words, if the thresholds are met a security document or article is classified as authentic.

The skilled person can envisage several modifications to the specific embodiments described above without departing from the spirit of the present invention. Such modifications are encompassed within the present invention.

### EXAMPLES

The present invention is now described in more details with reference to non-limiting examples. The examples E1-E16 and comparative examples C1-C8 below provide details on the preparation of the security inks described herein, as well as the magnetic and optical properties of machine-readable security features obtained therefrom.

### A. Magnetic Properties of the Machine-Readable Security Features

### A-1. Ferromagnetic Resonance (FMR) Signature

Ferromagnetic resonance of the machine-readable security features obtained from the inventive security inks E1-E16 and the comparative inks C1-C8 was assessed using a PhaseFMR-40 device (Nanosc Instruments AB, Kista, Sweden) equipped with a 5403 magnet from GMW Associates (San Carlos USA). The PhaseFMR-40 operated a CPW mode (coplanar waveguide), one which a 5 mm×5 mm sample of the security features was disposed upside down. To obtain the FMR spectrum of the measured sample, the RF frequency was fixed at 5 GHZ, while the magnetic field was swept between 0 and 2500 Oe in steps of 10 Oe. A lock-in field modulation having an amplitude of 20 Oe peak-to-peak and a frequency of 490 Hz was used, the resulting FMR spectrum being displayed as the first derivative of the resonance signal.

From the FMR spectrum, two parameters were obtained:
Line-center field (@ 5 GHZ): this is the field at which the FMR spectrum of the security feature crosses 0 (i.e. the field at maximum amplitude of the resonance signal).
Line-width: this is the line width at half height or half prominence of the resonance signal.

The line-center field and the line width in Oe measured at an RF frequency of 5 GHZ for the security features obtained from the inventive security inks E1-E16 and the comparative inks C1-C8 are reported in Table 7 below.

At the given fixed RF frequency, the line-center field and the line width only depend on the molar concentration of element M in the YI(M)G pigment (i.e. the number of iron atoms that have been replaced by element M in the crystal cell), irrespective of the type of ink as shown in Table 7.

### A-2. Integrated Magnetic Susceptibility

The integrated magnetic susceptibility of the machine-readable security features obtained from the inventive security inks E1-E16 and the comparative inks C1-C8 was assessed using a QCD200 Mag device from Giesecke & Devrient GmbH (München, Deutschland). It was measured according to Giesecke & Devrient guidelines (QCD 200 MAG operating manual Art. No 221312001) on homogenous samples of dried and/or cured inventive security inks E1-E16 and the comparative inks C1-C8.

The integrated magnetic susceptibility of the machine-readable security features obtained from the inventive security inks E1-E16 and the comparative inks C1-C8 are reported in Table 7 below.

### B. Optical Properties of the Machine-Readable Security Features

### B-1. L* Values

L* values of the machine-readable security features obtained from the inventive security inks E8-E16 and the comparative inks C4-C8 (screen-printing inks) were independently obtained from the measurement of the printed machine-readable security features according to CIELAB (1976), a* and b* being the color coordinates in a cartesian 2-dimensional space (a*=color value along the red/green axis and b*=color value along the blue/yellow axis). The L*a*b* values were independently measured with a spectrophotometer DC 45IR from Datacolor (measurement geometry: 45/0°; spectral analyzer: proprietary dual channel holographic grating. 256-photodiode linear arrays used for both reference and sample channels; light source: total bandwidth LED illumination). The L* values of the security features obtained from the inventive inks E8-E16 and the comparative inks C4-C8 are reported in Table 8 below.

### B-2. IR-Reflectance Spectra

The reflectance spectrum of the machine-readable security features made from the inventive security inks E8-E16 and the comparative inks C4-C8 was independently measured with the DC45IR from Datacolor between 400 nm and 1100 nm. The 100% reflectance was measured using the internal standard of the device. Reflectance values (in %) at selected wavelengths of the NIR range (700-1100nm) of the security features obtained from the inventive security inks E8-E16 and the comparative inks C4-C8 are reported in Table 8 below.

### C. Y₃Fe₅₋ₓMₓO₁₂-Based Pigments

Pigments P1 and P2-P7 were measured for their particle size d₅₀ by laser diffraction measurements (Beckmann Laser LS). The general formula of the pigments P1-P7 is Y₃Fe₅₋ₓAlₓO₁₂, the value of x varying between 0 and 1.5, corresponding to a ratio Al/Fe between 0 and 30 mol-%. The stoichiometry and the particle size d₅₀ of the pigments P1-P7 is given in Table 1 below:

TABLE 1
Pigments P1-P7 and their characteristics

| | | Al/Fe | Fe replacement | Particle size |
|---|---|---|---|---|
| Pigment P | Chemical formula | ratio | by Al [mol-%] | d₅₀ [μm] |
| P1 | Y₃Fe₅O₁₂ | 0 | 0 | 9.9 |
| P2 | Y₃Fe_{4.99}Al_{0.01}O₁₂ | 0.002 | 0.2 | 7.4 |
| P3 | Y₃Fe_{4.975}Al_{0.025}O₁₂ | 0.005 | 0.5 | 7.2 |
| P4 | Y₃Fe_{4.9}Al_{0.1}O₁₂ | 0.02 | 2 | 8.0 |
| P5 | Y₃Fe_{4.75}Al_{0.25}O₁₂ | 0.053 | 5 | 8.0 |
| P6 | Y₃Fe₄AlO₁₂ | 0.25 | 20 | 5.8 |
| P7 | Y₃Fe_{3.5}Al_{1.5}O₁₂ | 0.43 | 30 | 5.8 |

### D. Preparation of the Inventive Security Inks E1-E15 and Comparative Inks C1-C8

### D-1. Oxidatively Drying Intaglio Inks E1-E6 and Comparative Inks C1-C2

To prepare the inventive security inks E1-E6 and the comparative inks C1-C2, the ingredients listed in Table 2 were thoroughly mixed by hand with a spatula until they were visually homogeneous. The resulting pasty inks were independently ground on a three-roll mill (Bühler 200 SDV) in two passes at 25° C. (first pass at 6 bars and second pass at 12 bars).

The viscosity of the so-obtained intaglio magnetic oxidatively drying inks was measured on a Haake Roto Visco 1 rotational rheometer (40° C. and 1000 s⁻¹, cone plate of 20 mm, 0.5° geometry, truncated at 25 μm).

TABLE 2
Composition of the oxidatively drying intaglio inks E1-E6 and C1-C2

| | | C1 | E1 | E2 | E3 | E4 | E5 | E6 | C2 |
|---|---|---|---|---|---|---|---|---|---|
| Ingredients | | [wt-%] | | | | | | | |
| Phenolic | Bremapal 2035 | 14.9 | | | | | | | |
| resin | (Kraemer, 42.4%, | | | | | | | | |
| | phenolic modified rosin | | | | | | | | |
| | ester) cooked in tung | | | | | | | | |
| | oil (Interfat, CAS No | | | | | | | | |
| | 8001-20-5, 42.4%) + n- | | | | | | | | |
| | dodecane (Haltermann, | | | | | | | | |
| | CAS No 112-40-3, 15.2%) | | | | | | | | |
| Alkyd | Urakyd AD85 (Synres), | 29.26 | | | | | | | |
| resin | oxidative drying alkyd | | | | | | | | |
| | resin based on mixed oil | | | | | | | | |
| Alkyd | Vialkyd ® AR 680 | 12.54 | | | | | | | |
| resin | (Allnex), long oil | | | | | | | | |
| | oxidative alkyd resin | | | | | | | | |
| Filler | Omyalite 50 (calcium | 30.83 | 10.83 | 10.83 | 10.83 | 10.83 | 10.83 | 10.83 | 10.83 |
| | carbonate, Omya) | | | | | | | | |
| Wax | Carnauba, ethoxylated | 4.7 | | | | | | | |
| | (A. Smit Trading) | | | | | | | | |
| Pigment 1 | C.I. Pigment Yellow 83 | 3.84 | | | | | | | |
| | (Trust Chem, CAS-No | | | | | | | | |
| | 5567-15-7) | | | | | | | | |
| Pigment 2 | C.I. Pigment Orange 34 | 2.73 | | | | | | | |
| | (Ferro, CAS No 15793- | | | | | | | | |
| | 73-4) | | | | | | | | |
| Oxidative | Octa-Soligen Cobalt | 0.2 | | | | | | | |
| drier 1 | 12% (Co-octoate 12% | | | | | | | | |
| | in C₁₄-C₁₈ alkanes, | | | | | | | | |
| | OMG Borchers) | | | | | | | | |
| Oxidative | Octa-Soligen Manganese | 1 | | | | | | | |
| drier 2 | 8% (Mn-octoate 8% | | | | | | | | |
| | in C₁₄-C₁₈ alkanes, | | | | | | | | |
| | OMG Borchers) | | | | | | | | |
| Pigment P | P1 | | 20 | | | | | | |
| | P2 | | | 20 | | | | | |
| | P3 | | | | 20 | | | | |
| | P4 | | | | | 20 | | | |
| | P5 | | | | | | 20 | | |
| | P6 | | | | | | | 20 | |
| | P7 | | | | | | | | 20 |
| Viscosity | | 11.5 | 12.5 | 11.9 | 12.1 | 14.5 | 15.9 | 15.8 | 9.5 |
| [Pa · s] | | | | | | | | | |

### D-2. UV-Curing Intaglio Ink E7 and Comparative Ink C3

To prepare the inventive security ink E7 and the comparative ink C3, the ingredients listed in Table 3 were independently mixed at room temperature with a DAC 150 SP CM 31 speedmixer (Hauschild) for 3 minutes at 2500 rpm. The resulting pastes were independently ground on a three-roll mill (Bühler 200SDV) in three passes at 25° C. (a first pass at a pressure of 8 bars, a second and a third pass at a pressure of 11 bars).

The viscosity of the inks was determined as described hereabove under item D-1.

TABLE 3
Composition of the UV-curing intaglio inks E7 and C3

| | | C3 | E7 |
|---|---|---|---|
| Ingredients | | [wt-%] | |
| Resin 1 | Ebecryl ® 1657 (Allnex) | 28 | |
| | Fatty acid polyester acrylate oligomer stearic palmitic polyester | | |
| | tetraacrylate | | |
| Resin 2 | Ebecryl ® 53 (Allnex) | 8 | |
| | Reactive diluent propoxylated glycerol triacrylate (CAS No | | |
| | 52408-84-1) | | |
| Surfactant | Zephrym ™ 3300B (Croda) | 6 | |
| | Dodecylbenzenesulfonic acid salt of 2-amino-propane (CAS No | | |
| | 84961-74-0) | | |
| Photoinitiator | Omnirad 819 (IGM resins) | 8 | |
| | Bis(2,4,6-trimethlbenzoyl)phenylphosphineoxide (CAS No | | |
| | 162881-26-7) | | |
| Filler 1 | Omyalite 50 (Omya) Calcium carbonate (CAS No 1317-85-3) | 34.43 | 14.43 |
| Filler 2 | Finntalc M15 (Mondo Mineralis) Talc Mg-Silicate (CAS No | 3 | |
| | 14807-96-6) | | |
| Wax | Carnauba, ethoxylated (A. Smit Trading) (CAS No 8015-86-9) | 4 | |
| UV-stabilizer | Florstab UV-1 (Kromachem) | 2 | |
| Pigment 1 | C.I. Pigment Yellow 83 (Trust Chem, CAS-No 5567-15-7) | 3.84 | |
| Pigment 2 | C.I. Pigment Orange 34 (Ferro, CAS No 15793-73-4) | 2.73 | |
| Pigment P | P6 | 0 | 20 |
| Viscosity | | 14.5 | 14.9 |
| [Pa · s] | | | |

D-3. UV-Curing Hybrid (cat/rad) Screen Printing Inks E8-E14 and Comparative Inks C4-C6

To prepare the inventive security inks E8-E14 and the comparative inks C4-C6, the ingredients of the ink vehicles (i.e. all ingredients of the inks except the iridescent pigment and the pigments P1-P7) provided in Table 4 were mixed and dispersed at room temperature using a Dispermat (model CV-3) for 10 minutes at 2000 rpm. Pigments P1-P7 were then independently added (except for C4) and dispersed further at room temperature for 3 minutes at 2500 rpm. Finally, the iridescent pigment was added and dispersed at room temperature for 3 minutes at 2500 rpm.

Viscosity values provided in Table 4 were independently measured at 25° C. using a Brookfield viscosimeter (model “DV-I Prime”, spindle S27 at 100 rpm).

TABLE 4
Composition of the screen printing inks E8-E14 and comparative inks C4-C6

| | | C4 | E8 | E9 | E10 | E11 | E12 | C5 | E13 | E14 | C6 |
|---|---|---|---|---|---|---|---|---|---|---|---|
| Ingredients | | [wt-%] | | | | | | | | | |
| Cationic | Uvacure ® 1500 (Allnex), 7- | 27.5 | 23.56 | | | | | 26.51 | 25.51 | 23.56 | |
| monomer | oxabicyclo[4.1.0]hept-3- | | | | | | | | | | |
| | ylmethyl 7-oxabicyclo[4.1.0]hep- | | | | | | | | | | |
| | tane-3-carboxylate | | | | | | | | | | |
| | (CAS No 2386-87-0) | | | | | | | | | | |
| Cationic | DVE-2 (BASF), 1,1′-[oxy- | 5 | 4.27 | | | | | 4.82 | 4.64 | 4.27 | |
| monomer | bis(ethyleneoxy)]diethylene | | | | | | | | | | |
| | (CAS No 764-99-8) | | | | | | | | | | |
| Polyol | POLYOL R4631 (Perstorp), | 10 | 8.55 | | | | | 9.63 | 9.27 | 8.55 | |
| | Pentaerythritol, ethoxylated and | | | | | | | | | | |
| | propoxylated | | | | | | | | | | |
| | (CAS No 30374-35-7] | | | | | | | | | | |
| Cationic | CURALITE ™ OX TMPO | 5 | 4.27 | | | | | 4.82 | 4.64 | 4.27 | |
| monomer | (Perstorp), | | | | | | | | | | |
| | 3-ethyloxetane-3-methanol | | | | | | | | | | |
| | (CAS No 3047-32-3) | | | | | | | | | | |
| Radical | MIRAMER M4004 (Rahn), | 20 | 17.11 | | | | | 19.28 | 18.55 | 17.11 | |
| monomer | Pentaerythritol, ethoxylated, | | | | | | | | | | |
| | esters with acrylic acid | | | | | | | | | | |
| | (CAS No 51728-25-8) | | | | | | | | | | |
| Filler | Aerosik ® 200 (Evonik), SiO₂ | 2 | 1.71 | | | | | 1.93 | 1.86 | 1.71 | |
| | (CAS No 7631-86-9) | | | | | | | | | | |
| Anti-foaming | Tego ® Airex 900 (Evonik), | 2.5 | 2.14 | | | | | 2.41 | 2.32 | 2.14 | |
| agent | Siloxanes and silicones, di-Me, | | | | | | | | | | |
| | reaction products with silica | | | | | | | | | | |
| | (CAS No 67762-90-7) | | | | | | | | | | |
| Cationic | OMNICAT 440 (IGM Resins), | 4.13 | 3.52 | | | | | 3.98 | 3.82 | 3.52 | |
| photoinitiator | bis(p-tolyl)iodonium | | | | | | | | | | |
| | hexafluorophosphate | | | | | | | | | | |
| | (CAS No 60565-88-0) | | | | | | | | | | |
| Radical | Omnirad 1173 (IGM Resins), | 4.56 | 3.90 | | | | | 4.40 | 4.23 | 3.90 | |
| photoinitiator | 2-hydroxy-2-methylpropiophenone | | | | | | | | | | |
| | (CAS No 7473-98-5) | | | | | | | | | | |
| Photosensitizer | GENOCURE ITX * (Rahn), | 0.48 | 0.41 | | | | | 0.46 | 0.46 | 0.41 | |
| | 2-isopropyl-9H-thioxanthen-9-one | | | | | | | | | | |
| | (CAS No 5495-84-1) | | | | | | | | | | |
| Solvent | Propylene carbonate | 1.83 | 1.56 | | | | | 1.76 | 1.70 | 1.56 | |
| | (BRENNTAG- | | | | | | | | | | |
| | SCHWEIZERHALL) | | | | | | | | | | |
| | (CAS No 108-32-7 | | | | | | | | | | |
| Iridescent | Pyrisma ® T30-20 (Merck), | 17 | 17 | | | | | 17 | 17 | 17 | |
| pigment | iridescent yellow pigment | | | | | | | | | | |
| | with d50 = 14-19 μm | | | | | | | | | | |
| Pigment P | P1 | | 12 | | | | | | | | |
| | P2 | | | 12 | | | | | | | |
| | P3 | | | | 12 | | | | | | |
| | P4 | | | | | 12 | | | | | |
| | P5 | | | | | | 12 | | | | |
| | P6 | | | | | | | 3 | 6 | 12 | |
| | P7 | | | | | | | | | | 12 |
| Viscosity | | 550 | 800 | 780 | 735 | 750 | 725 | 725 | 700 | 755 | 740 |
| [mPa · s] | | | | | | | | | | | |

### D-4. UV-Curing Radical Screen Printing Ink E15 and Comparative Ink C7

To prepare the inventive security ink E15 and the comparative ink C7, the ingredients of the ink vehicles (i.e. all ingredients of the inks except the iridescent pigment and the YIG pigment P6) provided in Table 5 were mixed and dispersed at room temperature using a Dispermat (model CV-3) for 10 minutes at 2000 rpm. Pigment P6 was then added (except for C7) and dispersed further at room temperature for 3 minutes at 2500 rpm. Finally, the iridescent pigment was added and dispersed at room temperature for 3 minutes at 2500 rpm.

The viscosity of the inks was determined as described hereabove under item D-3.

TABLE 5
Composition of the screen printing inks E15 and C7

| | | C7 | E15 |
|---|---|---|---|
| Ingredients | | [wt-%] | |
| Radical | Genomer* 4316 (Rahn), aliphatic polyester urethane acrylate | 18.1 | 15.48 |
| oligomer | | | |
| Radical | Ebecryl ® 145 (Allnex), propoxylated neopentylglycol diacrylate | 24.6 | 21.04 |
| monomer | (CAS No 84170-74-1) | | |
| Radical | TMPTA (Allnex), trimethylolpropane triacrylate (CAS No | 31.5 | 26.95 |
| monomer | 15625-89-5) | | |
| Filler | Aerosil ® 200 (Evonik), SiO₂ (CAS No 7631-86-9) | 0.6 | 0.51 |
| Anti-foaming | Tego ® Airex 900 (Evonik), Siloxanes and silicones, di-Me, | 1.2 | 1.03 |
| agent | reaction products with silica (CAS No 67762-90-7) | | |
| Radical | SpeedCure TPO-L (Lambson), ethyl phenyl(2,4,6- | 3 | 2.57 |
| photoinitiator | trimethylbenzoyl)-phosphinate (CAS No 84434-11-7) | | |
| Radical | Omnirad 1173 (IGM Resins), 2-hydroxy-2- | 4 | 3.42 |
| photoinitiator | methylpropiophenone (CAS No 7473-98-5) | | |
| Iridescent | Pyrisma ® T30-20 (Merck), iridescent yellow pigment with | 17 | 17 |
| pigment | d50 = 14-19 μm | | |
| Pigment | P6 | 0 | 12 |
| Viscosity | | 1100 | 1450 |
| [mPa · s] | | | |

### D-5. Heat-Drying Solvent Screen Printing Ink E16 and Comparative Ink C8

The ingredients of the ink vehicle (i.e. all ingredients of the ink except the iridescent pigment and the YIG pigment) described in Table 6 were mixed and dispersed at room temperature using a Dispermat (model CV-3) during 10 minutes at 2000 rpm. Pigment P6 was then added (except for C8) dispersed for 3 minutes at 2500 rpm, and finally the iridescent pigment was added and dispersed for 3 minutes at 2500 rpm so as to obtain the solvent screen printing security inks C8 and E15 described in Table 6.

Viscosity values provided in Table 6 were independently measured at 25° C. using a Brookfield viscosimeter (model “DV-I Prime”, spindle S27 at 50 rpm).

TABLE 6
Composition of the screen printing inks E16 and C8

| | | C8 | E16 |
|---|---|---|---|
| Ingredients | | [wt-%] | |
| Resin | Neocryl ® B-728 (DSM), MMA homopolymer, ~65'000g/mol | 16.51 | 14.12 |
| Solvent 1 | Butoxyethyl acetate (Brenntag), CAS No 112-07-2 | 42.77 | 36.59 |
| Solvent 2 | UCAR ESTER EEP (DOW), ethyl 3-ethoxypropionate (CAS | 14.09 | 12.05 |
| | No 763-69-9) | | |
| Solvent 3 | Dowanol ™ DPM (DOW), (2-methoxymethylethoxy)propanol | 6.23 | 5.33 |
| | (CAS No 34590-94-8) | | |
| Filler | Aerosil ® 200 (Evonik), SiO₂ (CAS No 7631-86-9) | 0.33 | 0.28 |
| Anti-foaming | BYK-1752 (BYK), silicone-free defoamer | 3.07 | 2.63 |
| agent | | | |
| Iridescent | Pyrisma ® T30-20 (Merck), iridescent yellow pigment with | 17 | 17 |
| pigment | d50 = 14-19 μm | | |
| Pigment | P6 | 0 | 12 |
| Viscosity | | 2150 | 2650 |
| [mPa · s] | | | |

### E. Preparation of the Machine-Readable Security Features Obtained from the Inventive Security Inks E1-E16 and Comparative Inks C1-C8

E-1. Machine-Readable Security Features from the Oxidatively Drying Intaglio Inks E1-E6 and Comparative Inks C1-C2

The oxidatively drying intaglio inks E1-E6 and C1-C2 were independently printed with an Ormag intaglio proof-press, using an intaglio plate composed of a set of engravings of various depths (from about 20 μm to about 100 μm) and widths (from about 60 μm to about 500 μm), engraved with a “U”-shape, such as to simulate a “guilloche” pattern on banknotes. Said intaglio plate was heated at 60° C. and the oxidatively drying intaglio inks E1-E6 and C1-C2 were independently applied on fiduciary paper (BNP paper from Louisenthal, 100 g/m², 20 cm×4 cm) with a polymer hand-inking roller and the excess of ink was manually wiped off with a paper. The size of the guilloche pattern was 5.4 cm×2.5 cm.

The obtained security features were dried 7 days in the dark. 3 samples of each security ink were printed and submitted to the tests described hereabove under items A-1 and A-2.

E-2. Machine-Readable Security Features from the UV-Curing Intaglio Ink E7 and Comparative Ink C3

The UV-curing intaglio inks E7 and C3 were independently printed as described under item E-1. The printed security features were cured using a Technigraf AKTIPRINT 18-2 mercury UV-drier (with a belt speed of 10m/min corresponding to a dose of about 200 mJ/cm²). 3 samples of each security ink were printed and submitted to the tests described hereabove under items A-1 and A-2.

E-3. Machine-Readable Security Features from the UV-Curing Hybrid (Cationic/Radical) and Radical Screen Printing Inks E8-E15 and Comparative Inks C4-C7

The UV-curing screen printing inks E8-E15 and C4-C7 were independently applied by hand on a piece of fiduciary paper (BNP paper from Louisenthal, 100 g/m², 12 cm×4.5 cm) using a 90 thread/cm screen (230 mesh), so as to form a machine-readable security feature in the form of a cured coating layer having a thickness of about 20 μm. The printed pattern had a size of 3.5 cm×3.5 cm.

After the printing step, each security feature was cured by exposing said feature two times at a speed of 100 m/min to UV-Vis light under a curing unit from IST Metz GmbH (two lamps: iron-doped mercury lamp 200 W/cm²+mercury lamp 200 W/cm²). 3 samples of each security ink were printed and submitted to the tests described hereabove under items A-1-B-2.

E-4. Machine-Readable Security Features from the Heat-Drying Solvent Screen Printing Ink E16 and Comparative Ink C8

The heat-drying solvent screen printing inks E16 and C8 were independently applied by hand on a piece of fiduciary paper (BNP paper from Louisenthal, 100 g/m², 12 cm×4.5 cm) using a 90 thread/cm screen (230 mesh), so as to form a machine-readable security feature in the form of a dried coating layer having a thickness of 6-9 μm. The printed pattern had a size of 3.5 cm×3.5 cm.

After the printing step, each security feature was dried with a hot air drier at a temperature of about 50° C. for about one minute. 3 samples of each security ink were printed and submitted to the tests described hereabove under items A-1-B-2.

### F. Results for Machine-Readable Security Features from the Inventive Security Inks E1-E16 and Comparative Inks C1-C8)

### F-1. FMR Signature (Line-Width and Line-Center Field) and Integrated Magnetic Susceptibility

Table 7 displays the FMR signature properties (line-width and line-center field) and the integrated magnetic susceptibility of the machine-readable security features obtained by printing and drying and/or curing the inventive security inks E1-E16 and the comparative inks C1-C8. The tests were carried out according to the procedures described under items A-1 and A-2.

TABLE 7

| | | | Integrated |
|---|---|---|---|
| | FMR signature @ 5 GHz | | magnetic |
| | Line-center | Line width | susceptibility |
| Example | [Oe] | [Oe] | [*10⁻¹²m³] |

| | | |
|---|---|---|
| C1 | No signal | 0 |

| | | | |
|---|---|---|---|
| E1 | 1551 ± 27 | 547 ± 18 | 1464 |
| E2 | 1607 ± 52 | 504 ± 12 | 1802 |
| E3 | 1594 ± 12 | 487 ± 12 | 1838 |
| E4 | 1631 ± 20 | 445 ± 12 | 1408 |
| E5 | 1631 ± 20 | 420 ± 9 | 1334 |
| E6 | 1711 ± 10 | 235 ± 3 | 589 |
| C2 | 1730 ± 1 | 107 ± 2 | 145 |

| | | |
|---|---|---|
| C3 | No signal | 0 |

| | | | |
|---|---|---|---|
| E7 | 1708 ± 6 | 260 ± 2 | 634 |

| | | |
|---|---|---|
| C4 | No signal | 0 |

| | | | |
|---|---|---|---|
| E8 | 1524 ± 5 | 565 ± 4 | 1506 |
| E9 | 1574 ± 32 | 508 ± 2 | 1552 |
| E10 | 1614 ± 15 | 488 ± 5 | 1491 |
| E11 | 1644 ± 11 | 443 ± 6 | 1404 |
| E12 | 1647 ± 5 | 423 ± 2 | 1273 |
| C5 | 1743 ± 5 | 247 ± 7 | 100 |
| E13 | 1740 ± 1 | 254 ± 2 | 258 |
| E14 | 1720 | 244 | 532 |
| C6 | 1740 ± 2 | 115 ± 1 | 138 |

| | | |
|---|---|---|
| C7 | No signal | 0 |

| | | | |
|---|---|---|---|
| E15 | 1730 | 243 | 573 |

| | | |
|---|---|---|
| C8 | No signal | 0 |

| | | | |
|---|---|---|---|
| E16 | 1711 | 256 | 520 |

### F-2. Optical Properties (L*a*b *-Value and NIR-Reflectance)

Table 8 displays the optical properties of the machine-readable security features obtained by printing and drying/curing the inventive screen printing security inks E8-E16 and the comparative inks C4-C8. The tests were carried out according to the procedures described under items B-1 and B-2.

TABLE 8

| | | | | NIR reflectance | | | |
|---|---|---|---|---|---|---|---|
| | Visible color | | | 800 | 900 | 1000 | 1100 |
| Example | L* | a* | b* | nm | nm | nm | nm |
| C4 | 91.56 | −1.77 | 10.51 | 88.8 | 88.9 | 87.7 | 89.6 |
| E8 | 74.13 | 0.12 | 25.99 | 84.2 | 75.4 | 79.9 | 89.0 |
| E9 | 70.91 | 0.14 | 34.21 | 83.6 | 74.1 | 79.7 | 89.6 |
| E10 | 72.19 | 0.3 | 33.23 | 85.7 | 76.5 | 81.8 | 91.1 |
| E11 | 73.78 | 0.4 | 24.04 | 83.5 | 74.7 | 79.3 | 88.4 |
| E12 | 73.39 | 0.33 | 26.34 | 83.1 | 74.6 | 78.9 | 88.2 |
| C5 | 87.09 | −1.46 | 21.74 | 89.4 | 88.2 | 87.8 | 91.3 |
| E13 | 83.03 | −1.12 | 28.39 | 89.3 | 86.4 | 86.6 | 90.7 |
| E14 | 76.26 | −1.12 | 34.39 | 85.9 | 79.9 | 81.5 | 88.7 |
| C6 | 77.92 | −1.9 | 42.02 | 88.9 | 84.4 | 84.7 | 91.2 |
| C7 | 92.29 | −1.17 | 8.96 | 89.7 | 90.1 | 88.9 | 90.6 |
| E15 | 75.12 | −1.02 | 35.49 | 86.5 | 79.5 | 81.3 | 89.0 |
| C8 | 92.03 | −1.64 | 5.04 | 85.7 | 86.5 | 85.8 | 87.8 |
| E16 | 79.08 | −1.3 | 25.19 | 83.6 | 79.2 | 80.9 | 87.4 |

1. A security ink composition comprising at least one non-luminescent undoped Y₃Fe₅₋ₓMₓO₁₂-based pigment,
wherein x fulfils the condition 0≤x≤1.25;
M is selected from a group consisting of aluminum, gallium or calcium and mixtures thereof; and wherein an applied at least one machine-readable security feature derived from said security ink composition, after drying and/or curing, has an integrated magnetic susceptibility of at least about 200×10⁻¹²m³ and presents a ferromagnetic resonance (FMR) signature for authentication purposes.

2. The security ink composition according to claim 1, wherein x fulfils the condition 0.10≤x≤1.25.

3. The security ink composition according to claim 1, wherein x fulfils the condition 0.25≤x≤1.00.

4. The security ink composition according to claim 1, wherein M is aluminum.

5. The security ink composition according to claim 1, wherein said pigment is present up to 40 wt. % of the security ink composition.

6. The security ink composition according to claim 1, comprising at least one additional non-luminescent undoped Y₃Fe₅₋ₓMₓO₁₂-based pigment, wherein x fulfils the condition 0≤x≤5;
M is selected from a group consisting of aluminum, gallium or calcium or mixtures thereof;
and wherein an applied at least one machine-readable security feature derived from said security ink composition, after drying and/or curing, presents a ferromagnetic resonance (FMR) signature for authentication purposes.

7. The security ink composition according to claim 1, further comprising at least one machine-readable compound selected from the group consisting of luminescent pigments, IR-absorbing pigments or SERS compounds.

8. The security ink composition according to claim 1, wherein the security ink composition is an intaglio ink composition with a viscosity in the range of about 3 to 60 Pa·s at 40° C.

9. The security ink composition according to claim 1, wherein the security ink composition is a screen-printing ink composition with a viscosity in the range of about 0.05 to 5 Pa·s at 25° C.

10. A machine-readable security feature, comprising at least one security ink composition according to claim 1.

11. A security document or article, comprising at least one machine-readable security feature according to claim 10.

12. Security document or article according to claim 11, comprising at least one more additional and different security feature.

13. A method for authenticating a security document or article comprising the steps of:
a) providing a security document or article according to claim 11 comprising at least one machine-readable security;
b) defining at least one region of said security document or article containing said at least one machine-readable security feature for the purpose of FMR signal detection;
c) detecting and recording the FMR spectrum of the at least one machine-readable security feature, to provide a recorded FMR spectrum containing enough data points to establish at least one FMR signature;
d) either parametrizing or using directly the recorded FMR spectrum to establish at least one regionally defined FMR signature;
e) comparing the established at least one regionally defined FMR signature from step d) with at least one predefined or expected FMR signature;
f) determining the authenticity of the security document or article based on the comparison operation performed under step e).

14. The security ink composition according to claim 1, wherein the at least one machine-readable security feature is printed.

15. The security ink composition according to claim 5, wherein said pigment is present up to 20 wt. %.

16. The security ink composition according to claim 1, wherein x fulfils the condition 0≤x≤4.99.

17. The security ink composition according to claim 6, wherein the at least one machine-readable security feature is printed.
